(19) United States
(12) Patent Application Publication
(10) Pub. No.: US 2025/0127180 A1
(43) Pub. Date: Apr. 24, 2025

(54) PARTICLES COMPRISING DOUBLE STRANDED RNA AND USE OF SAME IN AGRICULTURE

(71) Applicants: YEDA RESEARCH AND DEVELOPMENT CO. LTD., Rehovot (IL); THE STATE OF ISRAEL, MINISTRY OF AGRICULTURE & RURAL DEVELOPMENT, AGRICULTURAL R, Rishon Lezion (IL); HARVESTR TECHNOLOGIES LTD., Rahat (IL)

(72) Inventors: Robert FLUHR, Rehovot (IL); Noam ALKAN, Herzelia (IL); Lena POVARENOV, Rishon LeZion (IL); Danielle DUANIS ASSAF, Rishon LeZion (IL); Pankaj CHOWDHARY, Rishon LeZion (IL); Gal ADMATI, Kibbutz Dorot (IL); Yael BAR LAVAN, Rehovot (IL)

(21) Appl. No.: 18/987,103

(22) Filed: Dec. 19, 2024

Related U.S. Application Data
(63) Continuation-in-part of application No. PCT/IL2023/050637, filed on Jun. 20, 2023.
(60) Provisional application No. 63/353,662, filed on Jun. 20, 2022.

(51) Int. Cl. A01N 63/60; A01N 25/34

(52) U.S. Cl. CPC A01N 63/60; A01N 25/34

(57) ABSTRACT

The present invention is directed to an anti-fungal composition including a plurality of particles including: at least one dsRNA molecule including a nucleic acid sequence complementary to at least one transcript of at least one essential gene of a fungus, and methods of using same.

### REFERENCE TO AN ELECTRONIC SEQUENCE LISTING

The contents of the electronic sequence listing (YEDA-VOL-P-028-PCT.xml; size: 32,692 bytes; and date of creation: Jun. 11, 2023) is herein incorporated by reference in its entirety.

### CROSS-REFERENCE TO RELATED APPLICATIONS

This application is a Continuation-in-part (CIP) of International Patent Application No. PCT/IL2023/050637 having International filing date of Jun. 20, 2023, which claims the benefit of priority of U.S. Provisional Patent Application No. 63/353,662, titled “POSTHARVEST APPLICATION OF DSRNA IN LAYERED DOUBLE HYDROXIDE (LDH)”, filed Jun. 20, 2022, the contents of which are incorporated herein by reference in their entirety.

### FIELD OF INVENTION

The present invention is in the field of agricultural compositions, and specifically to formulations for delivery of anti-fungal active agents, such as gene silencing polynucleotides.

### BACKGROUND

The prolonged procedure that fruit and vegetables pass from field to plate results in high accumulative losses at every step of the produce supply chain. Fungal pathogens are one of the main reasons for postharvest diseases and fruit and vegetable loss. Most fruit contamination occurs in the field, yet those insidious fungi infections remain latent until ripening. The fruit becomes more susceptible to fungal pathogenicity during ripening, as a result of the accompanying cell wall softening and decreased natural defenses. The latent fungal pathogens then switch to an aggressive necrotrophic stage, where postharvest disease symptoms appear.

Currently, fungicides are considered the most common and effective means to control fungal pathogens and decay development. However, fungicides possess inherent disadvantages. The major detriments are environmental and human health due to non-specificity and the risk of developing resistant fungi. Therefore, there is a global need to search for safer and eco-friendly, cost-effective alternatives to control fungal pathogens and the development of postharvest diseases.

The RNA interference (RNAi) system is a natural post-transcriptional gene silencing process in eukaryotic cells. RNAi is based on the recognition of double-stranded RNA (dsRNA) molecules, which lead to the degradation of a target messenger RNA (mRNA). Since small dsRNA molecules can be transferred from the host plant cell to the fungal cell and vice versa, new possibilities have arisen to control fungal pathogens. Two emerging technologies take advantage of the RNAi system. One method uses transgenic plants with host-induced gene silencing. That route is fettered by regulatory restrictions for genetically modified plants. In addition, it is hampered by the need to adjust transgenes to the ever-changing landscape of potential pathogens. Another method is spray-induced gene silencing (SIGS), where dsRNA is externally applied on the plant parts such as leaves, branches, or fruit. However, the SIGS approach is disadvantaged by its relatively expensive production costs and the inherent instability of dsRNA. Indeed, the relatively short lifetime in the environment has posed a major challenge for developing commercial topically-applied dsRNA products.

The availability and effectiveness of dsRNA depend on environmental factors such as UV radiation, humidity, and biological degradation (RNase enzymes and microbial degradation). To enhance dsRNA stability, there is a need to develop a formulation for delivery that will protect dsRNA; yet, allow its slow release and uptake by the fungi. One solution is to integrate dsRNA in layered double hydroxide (LDH) clay sheets. LDH is an inorganic layered material that occurs naturally due to saline precipitation. LDH is considered safe and is used in drug delivery. LDH features brucite-like compounds that form positively charged layers, allowing negatively charged dsRNA to enter between the layers and be protected from washing, RNase degradation, and UV exposure. Moisture and atmospheric CO₂ slowly break down LDH and discharge the loaded dsRNA. Indeed, the use of LDH delivery formulation for dsRNA was found to be easy and cost-effective, which enables plant protection from viruses.

Botrytis cinerea is among the most important and common necrotrophic fungal pathogens responsible for postharvest decay of fresh fruit and vegetables. B. cinerea has a wide range of hosts and can infect over 200 plant species, causing gray mold disease. B. cinerea is a pathogenic fungus capable of natural uptake of dsRNA from the environment. Several studies have demonstrated how the direct application of dsRNA may offer a short-term control against the pathogenic fungi B. cinerea. These studies used SIGS targeting virulence genes for B. cinerea and were capable of reducing decay development. Therefore, the ability to control B. cinerea and gray mold is a major objective in the development of new postharvest treatments.

While incorporation effectively limits viral and insect spread, little is known about its involvement in plant-fungal pathogen interactions.

There is still a great need for new technological approaches in order to deliver polynucleotides (e.g., gene silencing polynucleotides) in an agriculturally acceptable form so as to treat or prevent fungal infections.

### SUMMARY

The present invention, in some embodiments, is based, at least in part on the findings showing that direct dsRNA targeting three essential genes in the ergosterol biosynthesis pathway could offer protection against B. cinerea.

The present invention, in some embodiments, is further based, at least in part, on the findings showing that integration of dsRNA in layered double hydroxide (LDH) negatively affects fungal growth and decay development during long-term storage, and greatly increases the protection of dsRNA and efficacy of the treatment.

According to a first aspect, there is provided a method for treating or preventing a fungal infection in a plant in need thereof or a part thereof, the method comprising administering to at least a portion of the plant an effective amount of at least one double stranded RNA (dsRNA) molecule comprising a nucleic acid sequence complementary to at least two transcripts transcribed from at least two essential genes of a fungus inducing the fungal infection, thereby treating or preventing the fungal infection in the plant or a part thereof.

According to another aspect, there is provided a method for treating or preventing a fungal infection in a plant in need thereof or a part thereof, the method comprising administering to at least a portion of a plant an effective amount of a particle comprising: (i) at least one dsRNA molecule comprising a nucleic acid sequence complementary to at least two transcripts transcribed from at least two essential genes of a fungus inducing the fungal infection; and (ii) a layered double hydroxide (LDH), thereby treating or preventing a fungal infection in the plant or a part thereof.

According to another aspect, there is provided an anti-fungal composition comprising a plurality of particles comprising: (a) at least one dsRNA molecule comprising a nucleic acid sequence complementary to at least one transcript of at least one essential gene of the fungus; and (b) LDH.

In some embodiments, the particle comprises the at least one dsRNA molecule and the LDH at a mole per mole (m:m) ratio of between 1:20 and 1:80.

In some embodiments, the at least two essential genes are of the same pathway.

In some embodiments, the pathway is ergosterol production pathway.

In some embodiments, the at least two essential genes are selected from the group consisting of: 3-hydroxy-3-methylglutaryl-CoA synthase (erg13), Sterol 14-demethylase (CYP51), and Squalene monooxygenase (erg1).

In some embodiments, the at least two essential genes comprises all three of egr13, CYP51, and erg1.

In some embodiments, the at least one dsRNA molecule is of a length of between 500 base pairs (bp) and 1,000 bp.

In some embodiments, the at least one dsRNA molecule comprises a first RNA sequence derived from erg13, followed by a second RNA sequence derived from CYP51, followed by a third RNA sequence derived from erg1.

In some embodiments, any one of the first, second, and third RNA sequences is of a length of between 20 bp and 400 bp.

In some embodiments, the first, second, and third RNA sequences has a complementarity level of between 70% and 100% to erg13, CYP51, and erg1, respectively, or to a transcript thereof.

In some embodiments, the at least one dsRNA molecule comprises the nucleic acid sequence set forth in any one of SEQ ID Nos: 4-7.

In some embodiments, the fungus is selected from the division Ascomycota.

In some embodiments, the fungus belongs to a genus selected from the group consisting of: Botrytis, Alternaria, Aspergillus, Blumeria, Cercospora, Colletotrichum, Geotrichum, Fusarium, Lasiodiplodia, Magnaporthe, Monilinia, Mycosphaerella, Penicillium, Phytophthora, Puccinia, Rhizophus, Rhizoctoniat, Sclerotinia, Ustilago, and any combination thereof.

In some embodiments, the administering is by spraying, dipping, or both.

In some embodiments, the administering comprises multiple administrations.

In some embodiments, the multiple administrations are 1 week to 4 weeks apart.

In some embodiments, the method further comprises co-administering to the at least a portion of a plant an amount of a fungicide being at least 10% lower than an effective amount of the fungicide when administered alone.

In some embodiments, the at least a portion of a plant comprises any one of: a leaf, a fruit, a flower, and any combination thereof.

In some embodiments, the administering comprises post-harvest administration.

In some embodiments, the method further comprises subjecting the at least a portion of a plant to at least one abiotic condition selected from the group consisting of: CO2 level of between 0.01% to 5%, relative humidity of between 80% and 98%, and both.

In some embodiments, the subjecting is after the administering.

In some embodiments, the anti-fungal composition comprises at least one feature selected from the group consisting of: (i) Magnesium to Aluminum m:m ratio of between 2 and 4; (ii) Zeta potential of between 30 mV and 50 mV; and (iii) a particle size of between 150 nm and 350 nm.

In some embodiments, the anti-fungal composition is characterized by being capable of reducing or inhibiting at least one fungal activity for a period of between 1 and 6 weeks.

In some embodiments, the at least one essential gene encodes for at least one protein involved in the ergosterol production pathway.

In some embodiments, the at least one essential gene comprises three essential genes involved in the ergosterol production pathway.

In some embodiments, the three essential genes involved in the ergosterol production pathway are erg13, CYP51, and erg1.

In some embodiments, the anti-fungal composition is formulated for at least one administration route selected from the group consisting of: spraying and dipping.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIGS. 1A-1D include a map of the dsRNA-ERG template and fluorescent micrographs showing penetration of labeled dsRNA into conidia germination of B. cinerea. (1A) Map of dsRNA-ERG template made up of three essential genes in the ergosterol pathway: erg13, erg11, and erg1, flanked by T7 promoter and unique restriction enzymes sites (total 751 bases). (1B-1D) Conidia of the B. cinerea were germinated in the presence of Cy5-labeled dsRNA-Dicer (1C) or Cy5-labeled dsRNA-ERG (1D). The spores germinated on a PDA substrate for 12 h. The germinating conidia were observed under a confocal microscope. (1B) Germination of control after 12 h without dsRNA. (1C-1D) Conidia germination after 12 h in the presence of fluorescent dsRNA-Dicer or dsRNA-ERG, respectively.

FIGS. 2A-2D include vertical bar graphs and micrographs showing that dsRNA-ERG reduces germination and hyphal growth in vitro and in vivo. B. cinerea conidia were germinated in 0.2% SMB on glass slides. dsRNA-ERG was added to the growth media at time 0 or after 4 or 8 hours of incubation. Conidia germination was evaluated microscopically after 20 h of incubation. (2A) Germination percentage. (2B) Germ tube length. The presented data are mean and standard errors. Asterisks indicate statistically significant differences (P<0.05). (2C) Microscopic images (40× magnification) of B. cinerea conidia germination. (2D) Representative pictures of B. cinerea conidia germination and growth on grapes treated with water (control; upper picture) or dsRNA-ERG (lower picture).

FIGS. 3A-3C include photographs, graphs, and vertical bar graphs showing that dsRNA-ERG reduces decay development caused by Botrytis cinerea. Onion skin (3A), rose petals (3B) and strawberry (3C) were treated with water (control), Bc-DCL1/2-dsRNA (dsRNA-Dicer), or Bc-ERG1/13/11-dsRNA (dsRNA-ERG) following infection by B. cinerea. Decay diameter was measured and the area under the disease progress curve (AUDPC) was calculated for each experiment (7 dpi for onion skin, 6 dpi for rose petals, and 5 dpi for strawberry). The top panel shows representative photographs which were taken three days post-infection (dpi). The data presented are mean and standard errors. Values followed by different letters are statistically significant (P<0.05).

FIGS. 4A-4D include graphs, vertical bar graphs, and photographs showing that dsRNA-ERG reduces fruit decay caused by Botrytis cinerea. Hydrocarborundum powder was used to create micro-injuries in fruit cuticles of bell pepper (4A), cherry (4B), mango (4C), and grape (4D). The fruits were sprayed with water (control) or Bc-ERG1/13/11-dsRNA (dsRNA-ERG) following spray infection by B. cinerea. The decayed area was measured and the area under the disease progress curve (AUDPC) was calculated for each experiment (10 dpi for bell-pepper, 4 dpi for cherry, and mango, and 6 dpi for grape). The lower panel shows representative pictures taken four days post-inoculation (dpi). The presented data are mean and standard errors. Values followed by an asterisk indicate statistically significant differences (P<0.05).

FIGS. 5A-5H include vertical bar graphs and photographs showing the systemic effect of dsRNA-ERG. Bell-peppers (5A, 5C, and 5E) and tomato (5B, 5D, and 5F) were treated with water (control) or dsRNA-ERG at the upper-left corner of the fruit, following inoculation with B. cinerea at the dsRNA-ERG treatment point and two other points along the horizontal and vertical axes. The infection was conducted on the day of the treatment (5A-5B), or 1 (5C-5D), or 3 days post-treatment (5E-5F). Decay area was measured and the area under the disease progress curve (AUDPC) was calculated. 5G-5H are representative pictures of bell peppers and tomatoes (respectively) which were inoculated one day post-treatment. Representative pictures were taken Three (for bell peppers) or six (for tomatoes) days post-inoculation (dpi). The presented data are mean and standard errors. Values followed by different letters are statistically significantly different (P<0.05).

FIGS. 6A-6C include vertical bar graphs showing penetration of dsRNA-ERG to fruit pulp and down-regulation of gene expression. Grapes were treated with water (control) or dsRNA-ERG followed by spray inoculation with B. cinerea. Peel and pulp samples for RNA extraction were taken 8-, 24-, and 48-hours post-inoculation. (6A) Relative abundance of the applied dsRNA-ERG construct was evaluated by qPCR and normalized to the actin gene of grape at 8-, 24-, and 48-hours post-infection. (6B) Relative expression of erg11 gene at 8-24- and 48-hours post-infection, normalized to actin gene of B. cinerea in the grape peel or pulp. (6C) Relative expression of the three targeted genes by the dsRNA-ERG and two non-targeted genes in the ergosterol biosynthesis pathway, 48 hours post-inoculation in peel tissue. The data shown are means and standard errors. Asterisks indicate statistically significant differences (P<0.05).

FIGS. 7A-7D include graphs and a photograph showing that dsRNA application reduces the concentration of a fungicide needed for growth inhibition of B. cinerea. (7A) B. cinerea conidia were grown at room temperature in 1% SMB, or 1% SMB supplemented with dsRNA-ERG, or dsRNA-ERG and ergosterol O.D measurements at 600 nm were taken every hour. (7B) Grapes were treated with water (control), or dsRNA-ERG, or dsRNA-ERG and ergosterol, following spray inoculation with B. cinerea. Decay severity was recorded every day. (7C) Representative picture of grapes treated with water (control), or dsRNA-ERG, or dsRNA-ERG and ergosterol, following spray inoculation with B. cinerea were taken four days post-infection (dpi). (7D) B. cinerea conidia were incubated at room temperature in 1% SMB, or 1% SMB supplemented with various concentrations of Prochloraz, with or without dsRNA-ERG. O.D measurements at 600 nm were taken every hour. The presented data are mean and standard errors.

FIGS. 8A-8D includes a photograph and graphs showing characterization of the colloidal properties of LDH. (8A) Tyndall effect visualized in colloidal LDH dispersions upon irradiation with a laser beam (λ=633 nm). (8B) FT-IR spectrum of LDH in the region 500-4,000 cm⁻¹. (8C) Z-potential distribution of LDH by Doppler velocimetry. (8D) Size distribution of LDH by dynamic light scattering (DLS).

FIGS. 9A-9C include photographs showing dsRNA loading and release by LDH. (9A) Determination of LDH dsRNA loading capability. M, 100 bp DNA ladder; Lane 1, dsRNA. Lanes 2 to 7, dsRNA-LDH at mass ratios of 1:1, 1:5, 1:10, 1:20, 1:40, and 1:80, respectively. LDH-bound dsRNA in the well (see arrow). (9B) Release of dsRNA from dsRNA-LDH complex under acidic conditions. M, 100 bp DNA ladder; Lane 1, dsRNA. Lane 2, dsRNA-LDH complex (1:40). Lane 3, dsRNA-LDH complex treated with the release buffer. (9C) The ability of LDH to protect dsRNA degradation by Nuclease. M, 100 bp DNA ladder; Lanes 1 and 2, untreated dsRNA; Lane 1, naked dsRNA; Lane 2, dsRNA-LDH with the release buffer; Lane 3, naked dsRNA treated with nuclease; Lane 4, dsRNA-LDH with the release buffer pre-treated with a nuclease.

FIGS. 10A-10C fluorescent micrographs, micrographs, graphs showing LDH-dsRNA complex reduces B. cinerea germination and growth. (10A) dsRNA-cy5 penetration. B. cinerea conidia germination on PDA slides (left pictures) or on grapes cuticle (right pictures) for 16 hours treated with dsRNA (upper pictures) or LDH-dsRNA complex (lower pictures). The dsRNA was labeled with cy5. (10B) B. cinerea conidia germination. B. cinerea germination on slides at room temperature after 20 h of incubation in 0.2% SMB or 0.2% SMB supplemented with LDH, dsRNA, or LDH-dsRNA complex. (10C) B. cinerea-GFP growth inhibition. B. cinerea growth was measured by green fluorescence measurements in 1% SMB or 1% SMB supplemented with LDH, dsRNA, or LDH-dsRNA complex. Values followed by different letters are significantly different (P<0.05).

FIGS. 11A-11E includes photographs, vertical bar graphs, and micrographs showing that LDH-dsRNA complex reduces fruit decay caused by B. cinerea inoculation. (11A) Representative pictures of infected cherries, four days post-inoculation (dpi). (11B) Decay severity of cherries (index 0-5) at four dpi. (11C) Representative pictures of infected grapes at four dpi. (11D) Decay severity (index 0-5) of grapes at four dpi (11E). HR-SEM representative images of grape peels after water or LDH treatment, and 72 hours post-inoculation by B. cinerea. White arrows indicate the scar area. White lines represent 25 microns. Different letters are significantly different (P<0.05) by Tukey Kramer.

FIGS. 12A-12C LDH-dsRNA complex reduces natural decay development during storage. Grapes were treated with water (control), LDH, dsRNA, or LDH-dsRNA and stored at 0° C. for three weeks, followed by another week at 22° C. At the end of the experiment, the fruit were evaluated to decay severity (index 0-5) and decay incidence. (12A) Total decay incidence (% of fruit). (12B) Decay incidence caused by B. cinerea (% of fruit). (12C) Decay severity caused by B. cinerea (index 0-5). Different letters are significantly different (P<0.05) by Tukey Kramer.

FIGS. 13A-13I include graphs, vertical bar graphs, and photographs showing the prolonged effect of LDH-dsRNA complex. Grapes were treated with water (control), LDH, dsRNA, or LDH-dsRNA and stored at 0° C. (13A, 13D, and 13G) Disease progress curve of decay severity following infection after one, three or five weeks respectively. (13B, 13E, and 13H) Area under disease progress curve (AUDPC). (13C, 13F, and 13I) are representative pictures of infected grapes five days post-inoculation after 1, 3, or 5 weeks of storage, respectively. The presented data are mean and standard. Values followed by different letters are significantly different by Tukey Kramer (P<0.05).

FIGS. 14A-14D include graphs and photographs showing that storage conditions affect dsRNA release and treatment efficiency. Grapes were treated with water (control), LDH, dsRNA, or LDH-dsRNA and stored at 0° C. in an open box (14A, and 14C) or closed bags (14B, and 14D). After 2, 4, and 6 weeks, carborundum powder was used to create micro-injuries on the fruit's peel, followed by spray inoculation by conidia of B. cinerea. (14A) and (14B) Decay severity was recorded on days 3-5, and the area under the disease progress curve (AUDPC) was calculated. (14C) and (14D) are representative pictures of infected grapes five days post-inoculation after 6 weeks of storage, in an open or closed box, respectively. The presented data are mean and standard errors of the AUDPC levels normalized to control in an open box. Values followed by different letters are significantly different by Tukey Kramer (P<0.05).

FIG. 15 includes photographs showing severity decay evaluation scale.

FIGS. 16A-16C include micrographs and vertical bar graphs showing B. cinerea germination in the presence of various concentrations of dsRNA and LDH-dsRNA complex. A drop of 10 μl B. cinerea conidia at a concentration of 10⁵ conidia ml⁻¹ were germinated on a glass slide with 50 μl of 0.2% SMB media supplemented with dsRNA or LDH-dsRNA complex in various concentrations (15, 7.5, 3.75, and 1.875 ng/μl). The slides were incubated at room temperature for 20 hours. (16A) Representative pictures of B. cinerea germination in the various conditions. (16B) Germination percentages. (16C) Germination tube length. The presented data are mean and standard error. Values followed by different letters are significantly different (P<0.05).

FIGS. 17A-17B include vertical bar graphs showing post-inoculation decay incidences. Cherries (17A) and grapes (17B) were treated with hydrocarborundum to create micro-injuries. This was followed by spray treatment with water (control), LDH, dsRNA, and LDH-dsRNA. Fruits were then spray inoculated with B. cinerea conidia and kept in a humid chamber at 22° C. The percentage of decay incidence of rotten fruit per treatment was measured 4 days post-inoculation. Values followed by different letters are significantly different (P<0.05).

FIGS. 18A-18D include micrographs and spectra showing HR-SEM and EDS analysis of LDH and grape peel treated with LDH. (18A) LDH visualization (18B) EDS elements analysis of LDH. Magnesium (Mg) and aluminum (Al) are the elements representing LDH, Silicon (Si) is the silicon component from the glass material that benefits the LDH. (18C) Grape peel, treated with LDH. (18D) EDS elements analysis of grape peel treated with LDH. Carbon (C) is the organic material, aluminum (Al) represents the LDH, (Si) silicon is residual of hydrocarborundum, and Iridium (Ir) is the coating material of the sample. The white line represents 25 microns.

FIGS. 19A-19B include vertical bar graphs showing natural decay incidences and decay severity after cold storage. Grapes were treated with water (control), LDH, dsRNA, or LDH-dsRNA and stored without inoculation at 0° C. for three weeks. (19A) Decay incidence (% of fruit). (19B) Decay severity (index 0-5). Note, no statistical differences were found between the treatments.

FIG. 20 includes a vertical bar graph showing decay incidence in stored grapes according to decay type. Grapes were treated with water (control), LDH, dsRNA, or LDH-dsRNA and stored at 0° C., followed by another week at 22° C. The percentage of rotten fruits was evaluated, and the decay was classified according to the fungal pathogen that caused the decay. Values followed by different letters are significantly different (P<0.05).

FIGS. 21A-21C include vertical bar graphs showing decay incidence after long cold storage. Decay incidence in grapes five days post B. cinerea inoculation (21A) one, (21B) three and (21C) five weeks after the grapes were treated.

FIGS. 22A-22F include decay severity progress curves. Grapes were treated with water (control), LDH, dsRNA, or LDH-dsRNA and stored at 0° C. in an open box (top panel; 22A-22C) or closed bags (lower panel; 22D-22F). After 2, 4, and 6 weeks, hydrocarborundum powder was used to create micro-injuries on the fruit's peel followed by spray inoculation by conidia of B. cinerea. Decay severity was evaluated 5 days post-treatment. Values followed by different letters are significantly different (P<0.05).

FIGS. 23A-23C include vertical bar graphs showing decay incidence with or without modified atmosphere. Decay incidence in grapes five days post B. cinerea inoculation (23A) two, (23B) four, and (23C) six weeks post-treatment.

FIG. 24 includes a table summarizing the physiological parameters of stored grapes.

FIGS. 25A-25B includes a graph (25A) and a photograph (25B) showing a comparative assay between: control, Fe-LDH, Al-LDH, ‘naked’ dsRNA (‘dsRNA’), Al-LDH loaded with dsRNA (‘Al-LDH-dsRNA’), and Fe-LDH loaded with dsRNA (‘Fe-LDH-dsRNA’). The experiment included the treatment of grapes with each of the above tested agents for 4 weeks at 0° C., after which grapes were further inoculated with pathogenic fungus at 22° C. for 4 weeks. The Y axis in 25B reflects the area of the lesion (mm2).

### DETAILED DESCRIPTION

### Methods of Use

According to one aspect, there is provided a method for treating or preventing a fungal infection on a surface, of a liquid volume, or both. In some embodiments, the method comprises contacting a surface or a with an effective amount of a double stranded RNA (dsRNA) molecule as disclosed herein.

In some embodiments, the surface is a surface of a subject. In some embodiments, the surface is an artificial or synthetic surface. In some embodiments, the subject is a human subject. In some embodiments, the subject is a plant or a plant part.

In some embodiments, a liquid volume comprises a body of water. In some embodiments, the body of water is being used or suitable for culturing, rearing, growing, or any combination thereof, of an organism. In some embodiments, the organism is an aquacultured organism, including, but not limited to, a fish, a crustacean, a mollusk, etc.

In some embodiments, a liquid volume is consumed by a subject. In some embodiments, a liquid volume is of an edible composition or product.

According to one aspect, there is provided method for treating or preventing a fungal infection in a plant in need thereof or a part thereof.

In some embodiments, the method comprises administering to at least a portion of a plant an effective amount of a double stranded RNA (dsRNA) molecule.

In some embodiments, a dsRNA comprises at least one dsRNA.

In some embodiments, at least one dsRNA comprises a plurality of dsRNA molecules. In some embodiments, the plurality of dsRNA comprises a plurality of types of dsRNA. In some embodiments, each of the plurality of types of dsRNA molecules is complementary (e.g., targets or targeting) to a different an essential gene or transcript thereof.

In some embodiments, the method comprises administering to at least a portion of a plant an effective amount of a particle comprising: (i) at least one dsRNA molecule; and (ii) a layered double hydroxide (LDH).

In some embodiments, the method comprises administering to at least a portion of a plant an effective amount of an inhibitory or an interfering nucleic acid molecule.

According to one aspect, there is provided method comprising administering to at least a portion of a plant an effective amount of a double stranded RNA (dsRNA) molecule.

In some embodiments, at least one strand of dsRNA comprises a nucleic acid sequence complementary to at least two transcripts transcribed from at least two essential genes of a fungus inducing a fungal infection, thereby treating or preventing a fungal infection in a plant or a part thereof.

As used herein, the term “essential gene(s)” refers to any gene or gene product being crucial to cell growth or viability. The terms “essential”, “vital for cell viability or growth”, or “essential for cell survival and proliferation” are interchangeable. A gene is essential if inhibition of the function of such a gene or gene product will kill the cell or inhibit its growth as determined by methods known in the art. Growth inhibition can be monitored as a reduction or preferably a cessation of cell proliferation. Unless otherwise indicated, the term “essential gene” includes both “generally essential gene(s)” and “conditionally essential genes”. “Generally essential genes” are those which are strictly essential for cell survival or growth, or which are essential under the conditions to which the cell is normally exposed. Typically, such conditions are the normal in vivo conditions or in vitro conditions which approximately replicate those in vivo conditions.

In some embodiments, the methods described herein, which utilize essential genes, are carried out in conditions such that the gene product is required for survival, growth, or both, of a cell, including a fungus, comprising same.

In some embodiments, the essential gene or gene product is essential for growth, survival, or both, of a fungus comprising same.

In some embodiments, the essential gene or gene product is essential for the preparation or functionality of a cell component. In some embodiments, the cell component comprises the cell membrane.

As used herein, the term “conditionally essential gene” encompasses any gene or gene product that is essential for cell survival or proliferation in a specific environmental condition caused by the presence or absence of specific environmental constituents, pharmaceutical agents, including small molecules or biologicals, or physical factors such as radiation.

In some embodiments, at least two essential genes are of the same pathway. In some embodiments, the pathway comprises ergosterol production pathway. In some embodiments, at least two essential genes are essential for or involved in ergosterol production.

In some embodiments, at least two essential genes are selected: 3-hydroxy-3-methylglutaryl-CoA synthase (erg13), Sterol 14-demethylase (CYP51), and Squalene monooxygenase (erg1).

In some embodiments, at least two essential genes comprises all three of egr13, CYP51, and erg1. CYP51 and erg11 are interchangeable.

In some embodiments, ERG13 gene or transcript thereof comprises a nucleic acid sequence as disclosed in GenBank Accession No. XM_001552372.2, or is a functional analog thereof, having at least 70%, 80%, 90% 95%, 99% sequence identity or homology thereto, including any value and range therebetween. Each possibility represents a separate embodiment of the invention.

In some embodiments, the ERG13 gene or transcript comprises the nucleic acid sequence set forth in SEQ ID NO: 1.

In some embodiments, the dsRNA molecule comprises a first RNA sequence derived from erg13 (SEQ ID NO: 1). In some embodiments, the first RNA sequence comprises a nucleic acid sequence comprising at least 20, 100, 200, 250, or 300 contiguous bp of erg13 (SEQ ID NO: 1). In some embodiments, the first RNA sequence comprises a nucleic acid sequence of at least 20, 100, 200, 250, or 300 contiguous bp derived from erg13 (SEQ ID NO: 1). In some embodiments, the first RNA sequence comprises a nucleic acid sequence of at least 20, 100, 200, 250, or 300 contiguous bp complementary to erg13 (SEQ ID NO: 1). In some embodiments, the first RNA sequence comprises 20 to 350 bp, 70 to 300 bp, or 190 to 320 contiguous bp of erg13 (SEQ ID NO: 1). In some embodiments, the first RNA sequence comprises a nucleic acid sequence comprising 20 to 350 bp, 70 to 300 bp, or 190 to 320 contiguous bp derived from erg13 (SEQ ID NO: 1). In some embodiments, the first RNA sequence comprises a nucleic acid sequence comprising 20 to 350 bp, 70 to 300 bp contiguous bp complementary to erg13 (SEQ ID NO: 1). Each possibility represents a separate embodiment of the invention.

In some embodiments, a first RNA sequence of the dsRNA has a complementarity level of between 70% and 100% to erg13 (SEQ ID NO: 1) or to a transcript thereof.

In some embodiments, ERG11 gene or transcript thereof comprises a nucleic acid sequence as disclosed in GenBank Accession No. XM_001549911.2, or is a functional analog thereof, having at least 70%, 80%, 90% 95%, 99% sequence identity or homology thereto, including any value and range therebetween. Each possibility represents a separate embodiment of the invention.

In some embodiments, the ERG11 gene or transcript comprises the nucleic acid sequence set forth in SEQ ID NO: 2.

In some embodiments, the dsRNA molecule comprises a second RNA sequence derived from erg11 (CPY51) (SEQ ID NO: 2). In some embodiments, the second RNA sequence comprises a nucleic acid sequence comprising at least 20, 100, 200, 250, or 300 contiguous bp of erg11 (SEQ ID NO: 2). In some embodiments, the second RNA sequence comprises a nucleic acid sequence of at least 20, 100, 200, 250, or 300 contiguous bp derived from erg11 (SEQ ID NO: 2). In some embodiments, the second RNA sequence comprises a nucleic acid sequence of at least 20, 100, 200, 250, or 300 contiguous bp complementary to erg11 (SEQ ID NO: 2). In some embodiments, the second RNA sequence comprises 20 to 350 bp, 70 to 300 bp, or 190 to 320 contiguous bp of erg11 (SEQ ID NO: 2). In some embodiments, the second RNA sequence comprises a nucleic acid sequence comprising 20 to 350 bp, 70 to 300 bp, or 190 to 320 contiguous bp derived from erg11 (SEQ ID NO: 2). In some embodiments, the second RNA sequence comprises a nucleic acid sequence comprising 20 to 350 bp, 70 to 300 bp, or 190 to 320 contiguous bp complementary to erg11 (SEQ ID NO: 2). Each possibility represents a separate embodiment of the invention.

In some embodiments, a second RNA sequence of the dsRNA has a complementarity level of between 70% and 100% to erg11 (SEQ ID NO: 2) or to a transcript thereof.

In some embodiments, the ERG1 gene or transcript thereof comprises a nucleic acid sequence as disclosed in GenBank Accession No. XM_001547426.2, or is a functional analog thereof, having at least 70%, 80%, 90% 95%, 99% sequence identity or homology thereto, including any value and range therebetween. Each possibility represents a separate embodiment of the invention.

In some embodiments, the ERG1 gene or transcript comprises the nucleic acid sequence set forth in SEQ ID NO: 3.

In some embodiments, the dsRNA molecule comprises a third RNA sequence derived from erg1 (SEQ ID NO: 3). In some embodiments, the third RNA sequence comprises a nucleic acid sequence comprising at least 20, 100, 200, 250, or 300 contiguous bp of erg1 (SEQ ID NO: 3). In some embodiments, the third RNA sequence comprises a nucleic acid sequence of at least 20, 100, 200, 250, or 300 contiguous bp derived from erg1 (SEQ ID NO: 3). In some embodiments, the third RNA sequence comprises a nucleic acid sequence of at least 20, 100, 200, 250, or 300 contiguous bp complementary to erg1 (SEQ ID NO: 3). In some embodiments, the third RNA sequence comprises 20 to 350 bp, 70 to 300 bp, or 190 to 320 contiguous bp of erg1 (SEQ ID NO: 3). In some embodiments, the third RNA sequence comprises a nucleic acid sequence comprising 20 to 350 bp, 70 to 300 bp, or 190 to 320 contiguous bp derived from erg1 (SEQ ID NO: 3). In some embodiments, the third RNA sequence comprises a nucleic acid sequence comprising 20 to 350 bp, 70 to 300 bp, or 190 to 320 contiguous bp complementary to erg1 (SEQ ID NO: 3). Each possibility represents a separate embodiment of the invention.

In some embodiments, a third RNA sequence of the dsRNA has a complementarity level of between 70% and 100% to erg1 (SEQ ID NO: 3) or to a transcript thereof.

In some embodiments, any one of the first, second, third, or any combination thereof, of RNA is or constitutes at least one strand of the dsRNA disclosed herein.

In some embodiments, the dsRNA molecule is of a length of between 50 base pairs (bp) and 1,000 bp, 150 and 1,000 bp, 250 and 1,000 bp, 300 and 1,000 bp, 400 and 1,000 bp, 500 and 1,000 bp, 650 and 1,000 bp, 700 and 1,000 bp, 800 and 1,000 bp, 900 and 1,000 bp, or 950 and 1,000 bp. Each possibility represents a separate embodiment of the invention.

In some embodiments, and third RNA sequences has a complementarity level of between 70% and 100% to erg1 (SEQ ID NO: 3) or to a transcript thereof.

In some embodiments, the dsRNA molecule comprises a first RNA sequence derived from erg13, followed by a second RNA sequence derived from CYP51, followed by a third RNA sequence derived from the erg1.

In some embodiments, the dsRNA molecule comprises the nucleic acid sequence: ATGCTACGGTGGTACCAACGCCGTTTTCAACGCTGTCAACTGGGTAGAATCAT CTGCATGGGATGGAAGAGACGCCATTGTCGTTGCTGGAGATATTGCTCTATAT GCCAAGGGTGCTGCACGTCCAACTGGAGGTGCTGGAGCTGTTGCCATGTTGAT TGGACCAAATGCTCCAGTTGTTGTCGAGCCTGGTCTTCGCGGATCCTACATGCA ACATGCCTACGATTTCTACAA (SEQ ID NO: 4), or is a functional analog having 70-100% sequence identity or homology thereto.

In some embodiments, the dsRNA molecule comprises the nucleic acid sequence: CTGTTTTGACAACCCCCGTATTTGGCAAAGATGTAGTTTACGACTGCCCAAATG CGAAGTTGATGGAGCAAAAGAAGTTCATGAAAATTGGCTTGTCTACAGAAGCT TTCCGATCCTACGTCCCAATCATACAAATGGAGGTGGAAAACTTTATGAAGCG TTCTTCGGCGTTCAAAGGTCCAAAGGGAACTGCTGACATTGGTCCCGCTATGG CTGAAATCACCATCTACACTGCTTCGCACACTCTGCAAGGAAAGGAAGTCCGC GATCGATTCGATACCTCCTTTGCCTCTCTCTACCACGACCT (SEQ ID NO: 5), or is a functional analog having 70-100% sequence identity or homology thereto.

In some embodiments, the dsRNA molecule comprises the nucleic acid sequence: AGAAGCAGATTGTTATTTTGGCCATCTCACCATCATCGCAGATGGATATGCCTC CAAATTCCGCAAGCAATACATCAACAAAACTCCCATTGTCAAAAGTAAATTCT ACGCTCTAGAATTAATAGATTGTCCCATGCCAGCTCCCAATCATGGAATCGTA GTCCTCTCGGACGTCTCCCCAGTTCTCCTCTATCAAATCGGTACCCACGA (SEQ ID NO: 6), or is a functional analog having 70-100% sequence identity or homology thereto.

In some embodiments, the dsRNA molecule comprises the nucleic acid sequence: ATGCTACGGTGGTACCAACGCCGTTTTCAACGCTGTCAACTGGGTAGAATCAT CTGCATGGGATGGAAGAGACGCCATTGTCGTTGCTGGAGATATTGCTCTATAT GCCAAGGGTGCTGCACGTCCAACTGGAGGTGCTGGAGCTGTTGCCATGTTGAT TGGACCAAATGCTCCAGTTGTTGTCGAGCCTGGTCTTCGCGGATCCTACATGCA ACATGCCTACGATTTCTACAACTGTTTTGACAACCCCCGTATTTGGCAAAGATG TAGTTTACGACTGCCCAAATGCGAAGTTGATGGAGCAAAAGAAGTTCATGAAA ATTGGCTTGTCTACAGAAGCTTTCCGATCCTACGTCCCAATCATACAAATGGAG GTGGAAAACTTTATGAAGCGTTCTTCGGCGTTCAAAGGTCCAAAGGGAACTGC TGACATTGGTCCCGCTATGGCTGAAATCACCATCTACACTGCTTCGCACACTCT GCAAGGAAAGGAAGTCCGCGATCGATTCGATACCTCCTTTGCCTCTCTCTACCA CGACCTAGAAGCAGATTGTTATTTTGGCCATCTCACCATCATCGCAGATGGATA TGCCTCCAAATTCCGCAAGCAATACATCAACAAAACTCCCATTGTCAAAAGTA AATTCTACGCTCTAGAATTAATAGATTGTCCCATGCCAGCTCCCAATCATGGAA TCGTAGTCCTCTCGGACGTCTCCCCAGTTCTCCTCTATCAAATCGGTACCCACG A (SEQ ID NO: 7), or is a functional analog thereof, having at least 70%, 80%, 90%, 95, or 99% sequence homology or identity thereto, or any value and range therebetween. Each possibility represents a separate embodiment of the invention.

In some embodiments, the inhibitory or interfering nucleic acid molecule comprises RNA. In some embodiments, the inhibitory or interfering nucleic acid is a small hairpin RNA (shRNA) or small interfering RNA (siRNA).

Inhibitory nucleic acids useful in the present methods and compositions include antisense oligonucleotides, ribozymes, external guide sequence (EGS) oligonucleotides, siRNA compounds, single- or double-stranded RNA interference (RNAi) compounds such as siRNA compounds, modified bases/locked nucleic acids (LNAs), antagomirs, peptide nucleic acids (PNAs), and other oligomeric compounds or oligonucleotide mimetics which hybridize to at least a portion of the target nucleic acid, e.g., at least two essential genes or transcripts thereof, and modulate its function. In some embodiments, the inhibitory nucleic acids include antisense RNA, antisense DNA, chimeric antisense oligonucleotides, antisense oligonucleotides comprising modified linkages, interference RNA (RNAi), short interfering RNA (siRNA); a micro, interfering RNA (miRNA); a small, temporal RNA (stRNA); or a short, hairpin RNA (shRNA); small RNA-induced gene activation (RNAa); small activating RNAs (saRNAs), or combinations thereof.

As used herein “an interfering RNA” refers to any double stranded or single stranded RNA sequence, capable—either directly or indirectly (i.e., upon conversion)—of inhibiting or down regulating gene expression by mediating RNA interference. Interfering RNA includes but is not limited to small interfering RNA (“siRNA”) and small hairpin RNA (“shRNA”). “RNA interference” refers to the selective degradation of a sequence-compatible messenger RNA transcript.

As used herein “an shRNA” (small hairpin RNA) refers to an RNA molecule comprising an antisense region, a loop portion and a sense region, wherein the sense region has complementary nucleotides that base pair with the antisense region to form a duplex stem. Following post-transcriptional processing, the small hairpin RNA is converted into a small interfering RNA by a cleavage event mediated by the enzyme Dicer, which is a member of the RNase III family.

A “small interfering RNA” or “siRNA” as used herein refers to any small RNA molecule capable of inhibiting or down regulating gene expression by mediating RNA interference in a sequence specific manner. The small RNA can be, for example, about 18 to 21 nucleotides long.

As used herein, an “antagomir” refers to a small synthetic RNA having complementarity to a specific microRNA target, with either mispairing at the cleavage site or one or more base modifications to inhibit cleavage. In another embodiment, an “antagomir” refers to a small synthetic RNA having complementarity to a population of microRNA targets, with either mispairing at the cleavage site or one or more base modifications to inhibit cleavage.

The term “nucleic acid” is well known in the art. A “nucleic acid” as used herein will generally refer to any molecule (e.g., a strand) of DNA, RNA or a derivative or analog thereof, comprising nucleotides. Nucleotides are comprised of nucleosides and phosphate groups. The nitrogenous bases of nucleosides include, for example, naturally occurring purine or pyrimidine nucleosides as found in DNA (e.g., an adenine “A,” a guanine “G,” a thymine “T” or a cytosine “C”) or RNA (e.g., an A, a G, an uracil “U” or a C).

The term “nucleic acid molecule” includes but is not limited to single-stranded RNA (ssRNA), double-stranded RNA (dsRNA), single-stranded DNA (ssDNA), double-stranded DNA (dsDNA), small RNAs, circular nucleic acids, fragments of genomic DNA or RNA, degraded nucleic acids, amplification products, modified nucleic acids, plasmid or organellar nucleic acids, and artificial nucleic acids such as oligonucleotides.

In some embodiments, the particle comprises at least one dsRNA molecule and LDH at a mole per mole (m:m) ratio of between 1:20 and 1:30 (m:m), 1:20 and 1:40 (m:m), 1:20 and 1:50 (m:m), 1:20 and 1:60 (m:m), 1:20 and 1:70 (m:m), 1:20 and 1:80 (m:m), 1:20 and 1:100 (m:m), 1:10 and 1:100 (m:m), 1:30 and 1:40 (m:m), 1:30 and 1:60 (m:m), 1:30 and 1:80 (m:m), 1:40 and 1:60 (m:m), 1:40 and 1:70 (m:m), 1:40 and 1:80 (m:m), 1:50 and 1:60 (m:m), 1:50 and 1:70 (m:m), 1:10 and 1:80 (m:m), 1:60 and 1:70 (m:m), 1:60 and 1:80 (m:m), or 1:70 and 1:80 (m:m). Each possibility represents a separate embodiment of the invention.

As used herein, the term “functional analog” refers to any nucleic acid sequence encoding a protein product involved in or essential for ergosterol production, as disclosed herein, e.g., erg11, erg13, or erg1, and having at least 80%, 90%, 95%, or 99% the activity of a protein product encoded by any one of: erg11, erg13, and erg1. Each possibility represents a separate embodiment of the invention.

The terms “homology” or “identity”, as used interchangeably herein, refer to sequence identity between two amino acid sequences or two nucleic acid sequences, with identity being a stricter comparison. The phrases “percent identity or homology” and “% identity or homology” refer to the percentage of sequence identity found in a comparison of two or more amino acid sequences or nucleic acid sequences. Two or more sequences can be anywhere from 0-100% identical, or any value there between. Identity can be determined by comparing a position in each sequence that can be aligned for purposes of comparison to a reference sequence. When a position in the compared sequence is occupied by the same nucleotide base or amino acid, then the molecules are identical at that position. A degree of identity of amino acid sequences is a function of the number of identical amino acids at positions shared by the amino acid sequences. A degree of identity between nucleic acid sequences is a function of the number of identical or matching nucleotides at positions shared by the nucleic acid sequences. A degree of homology of amino acid sequences is a function of the number of amino acids at positions shared by the polypeptide sequences.

The following is a non-limiting example for calculating homology or sequence identity between two sequences (the terms are used interchangeably herein). The sequences are aligned for optimal comparison purposes (e.g., gaps can be introduced in one or both of a first and a second amino acid or nucleic acid sequence for optimal alignment and non-homologous sequences can be disregarded for comparison purposes). The optimal alignment is determined as the best score using the GAP program in the GCG software package with a Blossum 62 scoring matrix with a gap penalty of 12, a gap extend penalty of 4, and a frame shift gap penalty of 5. The amino acid residues or nucleotides at corresponding amino acid positions or nucleotide positions are then compared. When a position in the first sequence is occupied by the same amino acid residue or nucleotide as the corresponding position in the second sequence, then the molecules are identical at that position. The percent identity between the two sequences is a function of the number of identical positions shared by the sequences.

In some embodiments, % homology or identity as described herein are calculated or determined using the basic local alignment search tool (BLAST). In some embodiments, % homology or identity as described herein are calculated or determined using Blossum 62 scoring matrix.

In some embodiments, the fungus is selected from the division Ascomycota.

In some embodiments, the fungus belongs to a genus selected: Iternaria, Aspergillus, Blumeria, Botrytis, Cercospora, Colletotrichum, Geotrichum, Fusarium, Lasiodiplodia, Magnaporthe, Monilinia, Mycosphaerella, Penicillium, Phytophthora, Puccinia, Rhizophus, Rhizoctoniat, Sclerotinia, Ustilago, Septoria, and any combination thereof.

In some embodiments, the fungus is a species belonging to the Botrytis genus. In some embodiments, the fungus is Botrytis cinerea.

In some embodiments, administering is by: drenching, dipping, soaking, injecting, spraying, coating, or any combination thereof.

In some embodiments, administering is by spraying, dipping, or both.

In some embodiments, administering is in an open field, a greenhouse, a storage facility, or any combination thereof.

In some embodiments, administering is pre-harvest administration, post-harvest administration, or both. In some embodiments, administering is post-harvest administration. In some embodiments, administering comprises multiple administrations.

In some embodiments, in multiple administration, each administration event is at least 5 days apart, at least 6 days apart, at least 7 days apart, at least 9 days apart, at least 10 days apart, at least 12 days apart, at least 15 days apart, at least 20 days apart, at least 25 days apart, at least 30 days apart, at least 40 days apart, or any value and range therebetween. Each possibility represents a separate embodiment of the invention. In some embodiments, in multiple administrations, each Administration event is 5-20 days apart, 7-21 days apart, 7-28 days apart, 7-35 days apart, 5-30 days apart, or 6-30 days apart. Each possibility represents a separate embodiment of the invention. In some embodiments, the multiple administrations are 1 week to 4 weeks apart.

In some embodiments, the method further comprises co-administering to the at least a portion of a plant an amount of a fungicide. In some embodiments, the amount of the fungicide is at 5%, 7%, 9% 10%, 15%, 20%, 30%, or 50% lower than an effective amount of the fungicide when administered alone, or any value and range therebetween. Each possibility represents a separate embodiment of the invention.

In some embodiments, the at least a portion of a plant comprises any plant part being selected from: whole plant, plant cells, tissues, fruit, flower and organs. The plant may be in any form including cuttings and harvested material (e.g., fruit). In some embodiments, at least a portion of a plant comprises: fruit, roots, bulbs, fruit, tubers, corms, leaves, flowers, seeds, stems, callus tissue, nuts, grains, cuttings, root stock, scions, harvested crops including roots, bulbs, tubers, corms, leaves, flowers, seeds, stems, callus tissue, nuts, grains, fruit, cuttings, root stock, scions, or any combination thereof.

In some embodiments, the at least a portion of a plant comprises any one of: a leaf, a fruit, a flower, and any combination thereof.

In some embodiments, the method further comprises subjecting at least a portion of a plant to at least one abiotic condition selected from CO₂, humidity, or both.

In some embodiments, the method further comprises subjecting at least a portion of a plant to at least one abiotic condition selected from CO₂ level of between 0.01% to 5%, 0.1% to 5%, 0.5% to 5%, 1.0% to 5%, 2.0% to 5%, or 3% to 5%, relative humidity of between 80% and 98%, 85% and 98%, 90% and 98%, 92% and 98%, or 95% and 98%, and both. Each possibility represents a separate embodiment of the invention.

In some embodiments, the subjecting is after the administering.

Agricultural pests cause major yield and economic losses worldwide. Pests can develop resistance to chemical pesticides and breeding strategies faster than can be engineered for, hence there is an urgent need for alternatives in pest management strategies.

Development of RNAi biopesticides delivered by a carrier, which in turn is up-taken and delivered to the pest by the plant, could give an alternative to broad-spectrum chemical-based control measures for pests and pathogens, which would instead be targeted accurately and specifically with minimal off-target effects.

According to some embodiments, the herein disclosed composition and method of using same, are directed to pathogen or pest control. In some embodiments, the pathogen is a plant pathogen, e.g., phytopathogen. According to some embodiments, there is provided a method for preventing or treating a fungal infectious disease in a plant.

As used herein, the term “pathogen” and “pest” are interchangeable.

Plant pathogens and/or pest are common and would be apparent to one of ordinary skill in the art.

As used herein, the term “plurality” encompasses any integer equal to or greater than 2. In some embodiments, a plurality comprises at least 2, at least 3, at least 4, at least 5, at least 6, at least 7, at least 8, at least 9, or at least 10, or any value and range therebetween. Each possibility represents a separate embodiment of the invention.

In some embodiments, a polynucleotide comprises RNA, DNA, a synthetic analog of RNA, a synthetic analog of DNA, DNA/RNA hybrid, or any combination thereof. In some embodiments, a particle of the invention comprises a polynucleotide selected from: RNA, DNA, a synthetic analog of RNA, a synthetic analog of DNA, DNA/RNA hybrid, or any combination thereof.

As used herein, an “antisense oligonucleotide” refers to a nucleic acid sequence that is reversed and complementary to a DNA or RNA sequence.

As referred to herein, a “reversed and complementary nucleic acid sequence” is a nucleic acid sequence capable of hybridizing with another nucleic acid sequence comprised of complementary nucleotide bases. By “hybridize” is meant pair to form a double-stranded molecule between complementary nucleotide bases (e.g., adenine (A) forms a base pair with thymine (T) (or uracil (U) in the case of RNA), and guanine (G) forms a base pair with cytosine (C)) under suitable conditions of stringency. (See, e.g., Wahl, G. M. and S. L. Berger (1987) Methods Enzymol. 152:399; Kimmel, A. R. (1987) Methods Enzymol. 152:507). For the purposes of the present methods, the inhibitory nucleic acid need not be complementary to the entire sequence, only enough of it to provide specific inhibition; for example, in some embodiments the sequence is 100% complementary to at least nucleotides (nts) 2-7 or 2-8 at the 5′ end of the microRNA itself (e.g., the ‘seed sequence’), e.g., nts 2-7 or 20.

In some embodiments, the inhibitory nucleic acid has one or more chemical modifications to the backbone or side chains. In some embodiments, the inhibitory nucleic acid has at least one locked nucleotide, and/or has a phosphorothioate backbone.

In some embodiments, the inhibitory nucleic acid is an RNA interfering molecule (RNAi). In some embodiments, the RNAi is or comprises double stranded RNA (dsRNA).

In some embodiments, the inhibitory or interfering RNA is chemically modified. In some embodiments, the chemical modification is a modification of a backbone of the inhibitory or interfering RNA. In some embodiments, the chemical modification is a modification of a sugar of the inhibitory or interfering RNA. In some embodiments, the chemical modification is a modification of a nucleobase of the inhibitory or interfering RNA. In some embodiments, the chemical modification increases stability of the inhibitory or interfering RNA in a cell. In some embodiments, the chemical modification increases stability of the inhibitory or interfering RNA in vivo. In some embodiments, the chemical modification increases the stability of the inhibitory or interfering RNA in the open air, field, on a surface exposed to air, etc. In some embodiments, the chemical modification increases the inhibitory or interfering RNA's ability to induce silencing of a target gene or sequence, including, but not limited to an RNA molecule derived from a pathogen, as described herein. In some embodiments, the chemical modification is selected from: a phosphate-ribose backbone, a phosphate-deoxyribose backbone, a phosphorothioate-deoxyribose backbone, a 2′-O-methyl-phosphorothioate backbone, a phosphorodiamidate morpholino backbone, a peptide nucleic acid backbone, a 2-methoxyethyl phosphorothioate backbone, a constrained ethyl backbone, an alternating locked nucleic acid backbone, a phosphorothioate backbone, N3′-P5′ phosphoroamidates, 2′-deoxy-2′-fluoro-β-d-arabino nucleic acid, cyclohexene nucleic acid backbone nucleic acid, tricyclo-DNA (tcDNA) nucleic acid backbone, ligand-conjugated antisense, and a combination thereof.

In some embodiments, the inhibitory or interfering RNA is complementary to any location along a target sequence, e.g., a transcript of an essential gene(s) as disclosed herein. In some embodiments, the inhibitory or interfering RNA is complementary to a 3′ end of a target sequence, e.g., a transcript of an essential gene(s) as disclosed herein. In some embodiments, the inhibitory or interfering RNA is complementary to a sequence within the 3′ untranslated region of a target sequence, e.g., a transcript of an essential gene(s) as disclosed herein. In some embodiments, the target sequence is a gene or a transcript thereof, e.g., a transcript of an essential gene(s) as disclosed herein. In some embodiments, a transcript e.g., of an essential gene(s) as disclosed herein, comprises a pre-mRNA, a mature mRNA, an alternatively spliced mRNA, or any combination thereof.

In some embodiments, an effective amount is a therapeutically effective amount. In some embodiments, an effective amount is a prophylactically effective amount. In some embodiments, an effective amount is an inhibitory effective amount.

In some embodiments, any one of: therapeutically, prophylactically, inhibitory, and any combination thereof, is related to the fungal phytopathogen, e.g., an amount effective to treat a plant infected therewith, prevent an infection in a plant susceptible thereto, to inhibit a fungal or an activity thereof in a plant, or any combination thereof.

As used herein, the terms “treatment” or “treating” of a disease, disorder or condition encompasses alleviation of at least one symptom thereof, a reduction in the severity thereof, or inhibition of the progression thereof. Treatment need not mean that the disease, disorder, or condition is totally cured. To be an effective treatment, a useful composition herein needs only to reduce the severity of a disease, disorder, or condition, reduce the severity of symptoms associated therewith, or provide improvement to a patient or subject's quality of life. In some embodiments, alleviated symptoms of the disease, disorder, or condition.

As used herein, the term “prevention” of a disease, disorder, or condition encompasses the delay, prevention, suppression, or inhibition of the onset of a disease, disorder, or condition. As used in accordance with the presently described subject matter, the term “prevention” relates to a process of prophylaxis in which a subject is exposed to the presently described compositions or composition prior to the induction or onset of the disease/disorder process. The term “suppression” is used to describe a condition wherein the disease/disorder process has already begun but obvious symptoms of the condition have yet to be realized. Thus, the cells of an individual may have the disease/disorder, but no outside signs of the disease/disorder have yet been clinically recognized. In either case, the term prophylaxis can be applied to encompass both prevention and suppression. Conversely, the term “treatment” refers to the clinical application of active agents to combat an already existing condition whose clinical presentation has already been realized in a patient.

As used herein, “treating” comprises ameliorating and/or preventing.

In some embodiments, ameliorating comprises alleviating at least one symptom associated with a disease as described herein.

### Anti-Fungal Composition

According to another aspect, there is provided an anti-fungal composition comprising a plurality of particles comprising: (a) dsRNA molecule; and (b) LDH.

In some embodiments, the dsRNA comprises a nucleic acid sequence complementary to at least one transcript of at least one essential gene of the fungus. In some embodiments, the dsRNA comprises a nucleic acid sequence complementary to at least one transcript of at least one essential gene of a fungus targeted by the anti-fungal composition. In some embodiments, the anti-fungal composition is suitable for targeting a fungus.

In some embodiments, the anti-fungal composition comprises at least one feature selected from: (i) Magnesium to Aluminum m:m ratio of between 2 and 4; (ii) Zeta potential of between 30 mV and 50 mV; (iii) a particle size of between 150 nm and 350 nm; or any combination thereof.

In some embodiments, the Magnesium to Aluminum m:m ratio is between 2 and 4, 2 and 3, or 3 and 4. Each possibility represents a separate embodiment of the invention.

In some embodiments, the LDH comprises Magnesium. In some embodiments, the LDH comprises Aluminum. In some embodiments, the LDH comprises Ferrum (Iron). In some embodiments, the LDH comprises a mixture of Magnesium, and Aluminum or Ferrum.

In some embodiments, the particle size is between 150 nm and 350 nm, 150 nm and 200 nm, 150 nm and 250 nm, 150 nm and 300 nm, 190 nm and 300 nm, 190 nm and 330 nm, 200 nm and 350 nm, 200 nm and 300 nm, 250 nm and 350 nm, or 100 nm and 400 nm. Each possibility represents a separate embodiment of the invention.

In some embodiments, the anti-fungal composition is characterized by being capable of reducing or inhibiting at least one fungal activity for a period of between 1 and 6 weeks, 1 and 5 weeks, 1 and 4 weeks, 1 and 3 weeks, 1 and 2 weeks, 2 and 6 weeks, 3 and 6 weeks, 4 and 6 weeks, 3 and 5 weeks, or 2 and 4 weeks. Each possibility represents a separate embodiment of the invention.

In some embodiments, the fungal activity is selected from: cell proliferation, cell division, DNA synthesis, mycelium production, hyphae production, ergosterol production, secretion, or both, or any combination thereof.

In some embodiments, the at least one essential gene encodes for at least one protein involved in the ergosterol production pathway.

In some embodiments, the at least one essential gene comprises three essential genes involved in the ergosterol production pathway.

In some embodiments, the anti-fungal composition is formulated for at least one administration route selected from: spraying, dipping.

In some embodiments, the anti-fungal composition is formulated as a dip, a powder, a spray or a concentrate.

In some embodiments, the composition is formulated for administration by spraying. In some embodiments, the composition is formulated for administration as a spray or an aerosol. In some embodiments, the composition is formulated for administration by spraying, drenching, dipping, soaking, or injecting.

In some embodiments, there is provided an agricultural composition comprising an agriculturally effective amount of dsRNA and LDH. In some embodiments, agriculturally effective amount comprises therapeutically effective amount. In some embodiments, therapeutically effective amount is directed to an agricultured organism or crop. In some embodiments, the organism or crop comprises a sensitive or susceptible plant. In some embodiments, the plant is sensitive or susceptible to fungal infection.

In some embodiments, the carrier is an agriculturally acceptable carrier. In some embodiments, an agriculturally acceptable carrier comprises an environmentally acceptable carrier. Such carriers can be any material that an animal, a plant or the environment to be treated can tolerate. In some embodiments, the carrier comprises any material, which can be added to the particle of the invention, or a composition comprising same, without causing or having an adverse effect on the environment, or any species or an organism other than the pathogen. Furthermore, the carrier must be such that the particle or composition comprising same, remains effective for introducing a polynucleotide to a plant and/or preventing or treating a viral infectious disease in a plant. In some embodiments, the carrier is a nutraceutical carrier. In some embodiments, the carrier is an edible carrier.

In some embodiments, the agriculturally acceptable carrier is selected from a group of: a solvent, a surfactant, a dispersant, a sticking agent, a spreading agent, a synergist, a penetrant, a compatibility agent, a buffer, a defoaming agent, a thickener, a drift retardant, or any combination thereof.

In some embodiments, the agriculturally acceptable carrier is or comprises a surfactant.

In some embodiments, the w/w concentration of the agriculturally acceptable carrier within the composition is between 0.1 and 99%, between 0.1 and 1%, between 1 and 10%, between 10 and 20%, between 20 and 30%, between 30 and 50%, between 50 and 60%, between 60 and 80%, or between 80 and 90%, including any range between. Each possibility represents a separate embodiment of the invention.

In some embodiments, the carrier is a liquid carrier. In some embodiments, the carrier is configured to spraying applications.

In some embodiments, preventing or treating comprises reducing the survival of a pathogen. In some embodiments, preventing or treating comprises reducing the replication rate of a pathogen. In some embodiments, preventing or treating comprises reducing the tolerability of a pathogen to standard therapy and/or prophylactics. In some embodiments, preventing or treating comprises increasing the susceptibility and/or vulnerability of a pathogen to standard therapy and/or prophylactics.

In some embodiments, contacting comprises spraying the plant or a part thereof. In some embodiments, contacting comprises spraying in a vicinity of a plant or a part thereof. In some embodiments, contacting comprises spraying a growth medium comprising a plant. In some embodiments a growth medium comprise soil.

In some embodiments, vicinity is at a distance of 10 cm to 50 cm, 1 cm to 100 cm, 10 cm to 1 m, 0.5 m to 2.5 m, 1 m to 50 m, 0.1 m to 30 m. each possibility represents a separate embodiment of the invention.

In some embodiments, a plant part comprises at least one leaf of the plant. In some embodiments, a plant part comprises one or more leaves of the plant. In some embodiments, a plant part comprises at least a portion of the foliage of the plant. In some embodiments, a plant part comprises the foliage of the plant.

In some embodiments, the fungus is a pathogen. In some embodiments, the fungus is a pathogenic fungus. In some embodiments, the fungus is a plant pathogen. In some embodiments, the fungus is a phytopathogen. In some embodiments, the composition is an anti-phyto fungal composition. In some embodiments, the pathogen is a pathogen affecting human health. In some embodiments, the pathogen is a human pathogen.

### GENERAL

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

As used herein, the term “about” when combined with a value refers to plus and minus 10% of the reference value. For example, a length of about 1,000 nanometers (nm) refers to a length of 1,000 nm±100 nm.

It is noted that as used herein and in the appended claims, the singular forms “a”, “an”, and “the” include plural referents unless the context clearly dictates otherwise. Thus, for example, reference to “a polynucleotide” includes a plurality of such polynucleotides and reference to “the polypeptide” includes reference to one or more polypeptides and equivalents thereof known to those skilled in the art, and so forth. It is further noted that the claims may be drafted to exclude any optional element. As such, this statement is intended to serve as antecedent basis for use of such exclusive terminology as “solely”, “only” and the like in connection with the recitation of claim elements or use of a “negative” limitation.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Various embodiments and aspects of the present invention as delineated hereinabove and as claimed in the claims section below find experimental support in the following examples.

### EXAMPLES

Generally, the nomenclature used herein, and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells-A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, CT (1994); Mishell and Shiigi (eds), “Strategies for Protein Purification and Characterization-A Laboratory Course Manual” CSHL Press (1996); all of which are incorporated by reference. Other general references are provided throughout this document.

### Materials and Methods

Construction and Production of dsRNA

To silence the ergosterol pathway, dsRNA construct was designed using SnapGene (SnapGene® software, GSL Biotech) for three transcripts in the ergosterol biosynthesis pathway, erg11, erg1, and erg13 yielding 791 bp. Each sequence was chosen from an expressed region of 250-300 bp. The full sequence including flanking EcoR1 restriction sites and T7 transcriptional promoters was synthesized by GeneScript Inc as follows.

### ERG Construct

The ERG construct has combined sequences of 3 chosen essential genes from the ergosterol biosynthesis pathways (ERG13, ERG11=CYP51, and ERG1) in Botrytis cinerea B05.10, a total of 751 bp.

EcoRI restriction site
(SEQ ID NO: 8)
GAATTC.
T7 promoter sequence (sense)
(SEQ ID NO: 9)
TAATACGACTCACTATAGGGAGA.
(SEQ ID NO: 4)
ERG13 - 234 bp.
(SEQ ID NO: 5)
ERG11-CYP51 - 307 bp.
(SEQ ID NO: 6)
ERG1 - 210 bp.

The DCL1/DCL2 dicer using the sequence for DCL1 and DCL2 was cloned in a similar manner as shown above. Briefly, the DCL1/DCL2 dicer was cloned in a similar manner between the T7 transcriptional promoters using the following sequences for DCL1 and DCL2.

DCL1 - 252 bp
(SEQ ID NO: 10)
TGCGGAAGAACTTGAAGGTTTGCTACACAGTCAAATATGTACTGCAGAAG
ATCCCAGCTTGCTGCAGTACTCAATCAAAGGTAAACCTGAGACTCTTGCC
TACTATGATCCCTTGGGCCCGAAATTCAATACTCCTCTTTATCTTCAAAT
GCTCCCGCTTCTAAAAGACAATCCTATCTTTCGGAAGCCATTTGTATTTG
GGACAGAAGCCAGTAGAACTCTAGGATCTTGGTGTGTTGACCAGATCTGG
AC.
DCL2 - 238 bp
(SEQ ID NO: 11)
GGATGCCATTTGCTGCACGCCAAAAATACATCGAGCAGATCTTCGCCTTC
GAGTAAAGCTACCACTTCTATCTATTATCTACTATACCCCAGAGTCAAAT
ATCATCGTGACGAAAACTGTGGCGAGCCTGAGAAAGATTGTGCAAAGTCT
CAACATTTTCGAAGACCCCTACGTTTTGACACTAAAAAGGAGTGATAGCG
AAAAAAGTCAACGTGAGCTGGCGAAAGTACTCAAGAGT.

For RNA synthesis, a high yield transcription reaction was carried out based on Ambion MEGAscript protocol (Thermo Fisher Scientific). The plasmid templates were linearized by EcoR1 restriction where complete linearization was monitored by gel fractionation and purified by Wizard SV clean-up system (Promega). After RNA synthesis to produce two self-hybridized complementary RNA transcripts, DNA and single-stranded RNA were removed by nuclease digestion. The remaining dsRNA was purified on a solid-phase adsorption system to remove proteins and oligonucleotides. The integrity and efficiency of duplex formation of dsRNA were examined by agarose gel and spectrophotometry. Pure dsRNA was stored at −20° C. until usage. The dsRNA construct was tested for off-target sequences using siFi21 (Licensed by CC-BY-SA-4.0) as described previously by Luck S. et al., 2019. Briefly, siFi software was used to analyze the whole dsRNA-ERG sequence against all the genome sequences of B. cinerea (RefSeq: GCF_000143535.2), Alternaria alternata (RefSeq: GCF_001642055.1), Penicillium expansum (RefSeq: GCF_000769745.1), Vitis venifera (RefSeq: GCF_000003745.3), and human (RefSeq: GCF_000001405.39; all data was downloaded from NCBI database) using the default parameters to achieve higher sensitivity for off-targets. Additional off-target searches used the ERG construct from B. cinerea as a DNA gene query for BLAST technique. Some fungal pathogens closely related to Botrytis were detected at 90% identity and above. These included Monilinia, and Botryotinia sp. for ERG13; Botryotinia and Sclerotinia sp. for ERG11; ERG1, Botryotinia sp. and for. No significant homologies were detected to plant or animal DNA.

### Layered Double Hydroxide (LDH) Preparation and Characterization

LDH was synthesized by modification of the co-precipitation method previously described (Xu et al., 2006). Briefly, 10 mL of a mixed salt solution containing Mg(NO₃)₂ (3 mmol) and Al(NO₃)₃ (1 mmol) was quickly added to 40 mL NaOH solution (0.15 M) under vigorous stirring followed by 30 min stirring in the N2-purged flask. To avoid the preferential adsorption of carbonate ions by LDH, all the solutions were degassed under a vacuum, and all the synthetic steps were performed under the stream of N2. The LDH slurry was separated by centrifugation, dispersed in 40 mL of deionized water, and hydrothermally treated for 16 hours at 100° C. in a 45-mL Teflon-lined autoclave (Parr Instruments, Moline, IL, USA).

The measurement of size and Z-potential of LDH was conducted by using a Zetasizer ZS Nano (Malvern Instruments, Malvern, UK) equipped with a He—Ne laser (λ=633 nm). For the measurement of Z-potential, the electrophoretic mobility of the particles was measured by laser Doppler velocimetry, and the Z-potential values were calculated by the Smoluchowski approximation of Henry's equation. For the size determination, the dynamic light scattering (DLS) was detected at an angle of 175°, and the autocorrelation functions of the scattered light intensity were analyzed with DTS 5.0 software.

Fourier transform infrared (FT-IR) spectra were obtained on a Nicolet iS5 FTIR-ATR (Thermo Scientific, Waltham, Massachusetts, US) in the range of 4,000-500 cm⁻¹ at a resolution of 0.4 cm⁻¹.

For the integration, dsRNA-Dicer was mixed with the LDH and incubated under shaking (400 rpm) at 30° C. for 30 min. The protective ability of LDH against the nuclease digestion was studied by exposing naked dsRNA and LDH-incorporated dsRNA to benzonase endonuclease (Millipore, USA) treatment. Samples were treated for 30 min at 37° C., and dsRNA was released from the LDH complex by treating with acidic release buffer (4.11 mL of 0.2 M Na₂HPO₄+15.89 mL 0.1 M citric acid; pH 3) in a volume ratio of 5:1. Under these conditions, the activity of benzonase is inhibited. To visualize LDH-dsRNA attachment and release, the samples run on 1% agarose gel and ethidium bromide staining.

### Fungal Strains and Growth Media

Cultures of B. cinerea B05-10 were routinely grown on potato dextrose agar (PDA; Difco, New Jersey, USA) medium for 14 days at 22° C. Conidia were gently collected by suspension in sterile distilled water, filtered through four layers of sterile cheesecloth, and diluted to a concentration of 10⁵ conidia ml⁻¹ for in-vitro experiments or 10⁴ conidia ml⁻¹ for in-vivo experiments. Conidial concentration in the suspension was microscopically determined using a hemocytometer.

dsRNA uptake by B. cinerea

The synthesis of fluorescent dsRNA used to evaluate dsRNA uptake from either naked or LDH-dsRNA complex by B. cinerea as was described (Duanis-Assaf et al., 2021). PDA glass slides were prepared for in-vitro assessment of the dsRNA uptake by the fungal cells. Clean glass slides were immersed into a 50 mL tube containing PDA to create a thin PDA layer on the glass. The PDA slides were left to dry for 15 minutes in a biological hood following inoculation with B. cinerea conidia suspension (10 μl of 10⁵ conidia mL⁻¹) and 50 μl of cy5-labeled dsRNA or cy5-labeled dsRNA-LDH complex at a concentration of 15 ng/μl (total 750 ng). The slides were incubated in a humid petri dish for 12-16 hours at room temperature. To test dsRNA uptake in-vivo, grapes were treated with carborundum to create micro-injuries. Cy5-labeled dsRNA or cy5-labeled dsRNA-LDH complex in a concentration of 15 ng/μl were placed in droplets (50 μl in total). The treated grapes were inoculated by B. cinerea droplet (total 20 μl conidia suspension in a concentration of 10⁵ conidia mL⁻¹) and were incubated in a humid chamber at 25° C. for 24 hours. The conidia were examined under a confocal laser-scanning microscope (CLSM; Olympus IX81, Center Valley, PA).

Effect of dsRNA on Decay Development

All fruit and crops were purchased from a local grower. For non-wounding inoculation assays, yellow onion (Allium cepa) scale, a cultivated pink rose (Rosa) petals, and strawberries (Fragaria ananassa) cv. Gilli was treated with water (control) or dsRNA-ERG (15 ng/μl) following inoculation by a 7 μl drop of B. cinerea at a concentration of 10⁴ conidia ml⁻¹. The scales, petals, and fruit were incubated at 25° C. for 5-7 days. Decay diameter was measured daily. To measure the irregular shape of the decay, for each rot, the decay diameter was determined as the average of 3 diameters in different directions. Each experiment was conducted using at least 10 repeats for treatment, the experiment was repeated twice.

For wound inoculation assays red bell-peppers (Capsicum annuum), cherry cv. Sweet-Hart (Prunus cerasus), mango cv. Shelly (Mangiferae indica) or grapes cv. Autumn Royal and Scarlotta (Vitis vinifera) were pre-treated with hydrocarborundum powder (Fisher Scientific, Loughborough, UK) by gentle abrasing the fruit until the fruit peel lost its smooth texture without releasing cell sap, to create micro-injuries on the fruit cuticle which mimic natural wounding. Without such uniform infection, one cannot get reliable quantitative measurements of protection. Spray treatment of water (control) or dsRNA (15 ng/μl) was applied up to drainage following spray inoculation of B. cinerea conidia suspension at a concentration of 10⁴ conidia ml⁻¹. Fruits were stored at 25° C. for 6 days in humid chambers and either decay area or severity (index 0-5; 0-no decay, 1-mild decay, 5-severe decay) were measured.

### Effect of LDH-dsRNA Complex on Decay Development

Cherry cv. Sweet-Hart (Prunus cerasus) was harvested in the Golan Heights, Israel, and purchased from ‘Beresheet’ packing-house and grapes cv. Scarlotta (Vitis vinifera) were harvested from the Lachish area, Israel. The Cherries and grapes were gently pre-rubbed with carborundum powder (Fisher Scientific, Loughborough, UK) to create micro-injuries on the fruit cuticle. Spray treatment of water (control), LDH, dsRNA (15 ng/μl), or LDH-dsRNA complex (15 ng/μl) was applied up to drainage following spray inoculation of B. cinerea conidia suspension at a concentration of 10⁴ conidia mL⁻¹. Inoculated fruit were stored at 25° C. for six days in humid chambers, and severity (index 0-5; 0-no decay, 1-mild decay, 5-severe decay) was measured. Forty fruits were used in each treatment for each cultivar.

### Evaluation of Systemic Protection

Red bell peppers (Capsicum annuum) and tomatoes (Solanum lycopersicum) were pre-treated with hydrocarborundum powder to create micro-injuries. Ten (10) μl drop of water (control) or dsRNA-ERG (15 ng/μl) was placed on the top-left point of the fruit. Inoculation was conducted at three time points: treatment day, one day after treatment, or three days after treatment using a 7 μl drop of B. cinerea at a concentration of 10⁴ conidia ml⁻¹. B. cinerea conidia were seeded at five inoculation points: the treatment point (T) and four additional points in a distance of 2 and 4 cm for bell-peppers or 1.5 and 3 cm for tomatoes, positioned vertically and horizontally. Fruits were stored at 25° C. for 7 days post-inoculation, in humid chambers and the decayed area was measured.

### Effect of LDH-dsRNA Complex on Conidia Germination

The effect of the LDH-dsRNA complex on B. cinerea conidia germination was tested in-vitro (Galsurker et al., 2020; Gatto et al., 2011). Briefly, conidia suspension (10 μl) was seeded on a glass slide, containing 0.2% Sabouraud maltose broth [SMB; 10 gr Peptone (Difco), 40 gr Maltose (Caisson labs, Smithfield, Utah, United States) per 1 L] with or without 15 ng/μl dsRNA or LDH-dsRNA complex. The conidia were incubated in a humid petri dish for 16 hours at room temperature. The conidia germination was examined under a microscope (Leica DM500 equipped with a Leica ICC50 HD camera). The percentage germination and germ tube length were evaluated using ImageJ software (rsb.info.nih.gov/ij) in three microscopic fields for each droplet, six droplets for each treatment.

RNA Extraction and Transcript Expression (Quantitative PCR; qPCR)

Vitis vinifera cv. Superior or Scarlota inoculated with B. cinerea and treated with water (control) or dsRNA-ERG as described above. The fruit peels or pulps were collected 8, 24, and 48 hours post-inoculation to liquid nitrogen. For RNA extraction, the peels or pulps were grounded to a fine powder using mortar and pestle and total RNA was extracted using Spectrum™ plant total RNA kit (Sigma-Aldrich, St. Louis, Missouri, United States) according to the manufacturer's instructions, following DNase treatment (TURBO DNA-free Kit, Ambion Life Technologies, USA). Total RNA (1 μg) was used for cDNA construction using the RevertAid First-Strand cDNA Synthesis kit (Thermo Scientific, USA) according to the manufacturer's instructions. cDNA samples were diluted at 1:10 and used for qRT-PCR. The relative expression of the three ergosterol targeted genes (erg11, erg1, and erg13) and two ergosterol non-targeted genes (erg3 and erg9) was evaluated by a qRT-PCR analysis conducted with a Step One Plus Real-Time PCR (Applied Biosystems, USA). PCR amplification was performed with 3 μL of diluted cDNA template in a 10 μL reaction mixture containing 5 μL Syber Green (Applied Biosystems) and 250 nM primers. The qRT-PCR analysis was conducted with the corresponding primer sets of the selected genes. All the primers were chosen from the transcript sequence region that was not part of the dsRNA-ERG construct to avoid cross-contamination. The primers that were used in the current study are: forward, 5′-GCTGATCTCCCTGCTCTCAAGTA-3′ (SEQ ID NO: 12) and reverse, 5′-TGTGGAGGCGTAGAGTTTCCTT-3′ (SEQ ID NO: 13) for erg11. Forward, 5′-GAGGAAAGCGTGTGCAAGCT-3′ (SEQ ID NO: 14) and reverse, 5′-TTCGCCCGTAGATGGATTGG-3′ (SEQ ID NO: 15) for erg1. Forward, 5′-AAGAAGCGTTTCAACGAGCG-3′ (SEQ ID NO: 16) and reverse, 5′-AGGGCGGCACTATCAACATT-3′ (SEQ ID NO: 17) for erg13, forward, 5′-TGGAAGTGACCGACAAATAC-3′ (SEQ ID NO: 18) and reverse, 5′-GAGGGTTGTGCCATTGAT-3′ (SEQ ID NO: 19) for erg3, forward, 5′-TCACCCATTTCACCCAGTTT-3′ (SEQ ID NO: 20) and reverse, 5′-GTTGATCCGAGTCCGTCTATTG-3′ (SEQ ID NO: 21) for erg9, and to evaluate the dsRNA-ERG construct we used forward 5′-TACCTCCTTTGCCTCTCTACC-3′ (SEQ ID NO: 22) located on erg13 sequence and reverse 5′-GTATTGCTTGCGGAATTTGGAG-3′ (SEQ ID NO: 23) located on erg 11 sequence. PCR cycling program included: 10 min at 94° C., followed by 40 cycles of 94° C. for 10 s, 60° C. for 15 s, and 72° C. for 20 s. The expression of the selected genes was normalized using Ct values of B. cinerea actin (forward, 5′-TGCTCCAGAAGCTTTGTTCCAA-3′ (SEQ ID NO: 24) and reverse, 5′-TCGGAGATACCTGGGTACATAG-3′) (SEQ ID NO: 25) or grape actin (forward, 5′-CTTGCATCCCTCAGCACCTT-3′ (SEQ ID NO: 26) and reverse, 5′-TCCTGTGGACAATGGATGGA-3′) (SEQ ID NO: 27) as reference gene, and expression values were calculated relatively to control sample (water treated) using Step One software v2.2.2 (Applied Biosystems). Each treatment consisted of three biological repeats and three technical replicates.

### In-Vitro Fungal Growth

To evaluate fungal growth inhibition by naked dsRNA or LDH-dsRNA, 6 μl conidia suspension at a concentration of 10⁵ conidia mL⁻¹ of B. cinerea expressing GFP (Leroch et al., 2011) was seeded in a black 96-well plate (Greiner, Kremsmünster, Austria), containing 200 μl of PDB. LDH-dsRNA complex or dsRNA alone in a concentration of 15 ng/μl were added to each well. The plates were incubated at room temperature, and GFP measurements at 488 nm excitation and 509 nm emission were taken every hour for 50 hours using Synergy LX plate reader (BioTek, Winooski, Vermont, United States). The fluorescent intensity of three wells of repeats was averaged together and was background-corrected by subtracting the average fluorescent intensity of treatment without fungi (Galsurker et al., 2020; Langvad, 1999).

To test the effect of commonly used fungicide on B. cinerea growth, ‘Procloraz’ (Sportak, Bayer Cropscience LLC, Monheim am Rhein, Germany) or ‘fludioxonil’ (scholar, Hod-Hasharon, Israel) fungicide were diluted in 1% SMB to final concentrations of 1-1000 ppb or 0.01-1,000 ppb, respectively.

The plates were incubated at room temperature and O.D measurement at 600 nm was taken every hour for 48-72 hours using Synergy LX plate reader (BioTek, Winooski, Vermont, United States). The absorbance of three wells of repeats was averaged together and was background-corrected by subtracting the average absorbance of media alone at time zero (Galsurker et al., 2020; Langvad, 1999). Growth inhibition percentage was calculated (O.D in control well−O.D in treatment well)/O.D in control well×100) (Meletiadis et al., 2003). Coefficient treatment interaction (CTI) was calculated as follows: CTI=AB/(A×B). AB is the ratio of the treatment combination to control; A, or B is the ratio of the single treatment to control. Coefficient treatment interaction is considered as synergistic when CTI<1 (Chen et al., 2014).

### Characterization of LDH Treated Grapes Using a Scanning Electron Microscope

Grapes were washed and disinfected using 70% ethanol. After drying, the grapes were gently rubbed with carborundum powder followed by a spray treatment of water or LDH. Half of the fruit were inoculated with 10 μl B. cinerea conidia (10⁵ conidia mL⁻¹). Grape peel samples were taken for high-resolution scanning electron microscope (HR-SEM) imaging and energy dispersive spectroscopy (EDS) for elemental analysis. Uninoculated samples were taken immediately after treatment, while inoculated samples were taken after 72 hours of incubation. The samples were immersed in 4% formaldehyde for 24 hours, followed by dehydration by immersing in increasing ethanol concentrations (25, 50, 75, 90, 95, and 100%) and left to air dry. For LDH characterization, LDH suspension was dropped on a cleaned silicon wafer and dried under a vacuum for 24 hours. The grape peels were mounted onto a silicon stub and sputter-coated with iridium before the HR-SEM visualization. The SEM images were obtained using a Sirion XL30 SFEG HR-SEM (ThermoFisher Scientific, Waltham, MA, USA). EDS was performed using an electron beam of 5 μm in diameter and an X-ray detector system attached to the SEM. The method allowed relative amounts of magnesium (Mg), and Aluminum (Al) to be determined.

### Effect of LDH-dsRNA Complex on Fruit Quality in Long-Term Storage

Grapes were spray treated with water (control), LDH, dsRNA (15 ng/μl), or LDH-dsRNA complex (15 ng/μl) up to drainage. A hundred (100) fruit per treatment divided into four repeats in plastic fruit storage containers. The grapes were cold stored (CS) at 0° C. for three weeks, following incubation at shelf life (SL) 22° C. for an additional week. The fruit quality was examined at each time point (after CS and after SL).

Physiological parameters: Fruit firmness is determined by placing the fruit horizontally on the turntable of a small-fruit firmness analyzer (Firmtech II; BioWorks, Wamego, KS, USA) with a flat 15 mm probe, measuring force deformation compression with a load-cell of 350 g, 20 fruit per treatment were measured at each time point (Weksler et al., 2015). Total soluble sugars (% TSS) were measured from the juice of fruit pulp (each replicate contained juice from 5 fruit) using Palette digital-refractometer PR-1 (Model DBX-55, Atago, Japan) for three measurements per treatment at each time point. The acidity was determined as malic or tartaric acid (for cherry or grape respectively) equivalent mass in 1 mL of pulp juice (each replicate contained juice from 5 fruit) that was dissolved in 40 mL of double-distilled water, using an automatic titratometer (Model 719 s, Titrino Metrohm Ion Analysis Ltd., Switzerland), three measurements per treatment in each time point.

Decay severity evaluation: Decay severity was evaluated at the end of CS and SL on a 0-5 index scale with 6 steps of severity, in which zero=no decay, and five=severe decay. The decay severity scale can be found in (FIG. 15). The presented results are the means±SE of measurements. Total decay incidences were determined by calculating the percentage of decayed fruit at the end of CS or SL per plastic box in each treatment. The results are presented as means±SE in each treatment.

Effect of LDH-dsRNA Complex on Decay Development after Long-Term Storage

Grapes were sprayed with water (control), LDH, dsRNA (15 ng/μl), or LDH-dsRNA complex (15 ng/μl) up to drainage. The grapes were stored at 0° C. (CS), and 30 grapes from each group were taken after 1, 3, and 5 weeks of storage for infection experiments. Then, thirty grapes for each treatment were gently rubbed with carborundum powder to create micro-injuries on the fruit cuticle following spray inoculation of B. cinerea conidia suspension at a concentration of 10⁴ conidia mL⁻¹. Fruit were stored at 25° C. for six days in humid chambers, and decay severity (index 0-5; 0-no decay, 1-mild decay, 5-severe decay) was measured.

Effect of LDH-dsRNA Complex on Decay Development after Long-Term Storage with Different Atmospheric Conditions

Grapes cv. Red Globe were spray treated with water (control), LDH, dsRNA (15 ng/μl), or LDH-dsRNA complex (15 ng/μl) up to drainage. The grapes were stored at 0° C. (CS) in an open box to minimize CO₂ accumulation or in modified atmosphere liners (GR-4, Xtend®, Stepac Ltd., Tefen, Israel). After 2, 4, and 6 weeks of storage, the CO₂ levels were measured in the closed bags using Oxybaby (WITT, Witten, Germany), and 30 grapes from each group were taken for inoculation experiments. The grapes were treated with carborundum powder to create micro-injuries on the fruit cuticle, followed by spray inoculation of B. cinerea conidia suspension at a concentration of 10⁴ conidia mL⁻¹. The fruit was then stored at 25° C. for six days in humid chambers, and decay severity (index 0-5 with increments of one; 0-no decay, 5-severe decay) was measured. The area under the disease progress curve (AUDPC) was calculated using trapezoid approximation:

$$AUDPC = {\sum }_{i = 1}^{n - 1} \frac{{y}_{i} + {y}_{i + 1}}{2} \times ( {t}_{i + 1} + {t}_{i} ) .$$

Since no significant difference was found between the control treatments in both of the storage conditions, the control (water-treated grapes in an open box) average AUDPC values at each time point was set as 100%, and the AUDPC values of each treatment were normalized compared to the control: Normalized AUDPC=AUDPC values of treatment/AUDPC of controls×100. Due to technical problems, the decay severity of water-treated grapes in modified atmosphere bags was not recorded after four weeks of storage.

### Statistical Analysis

The data presented are averages and standard errors. A t-test was performed to compare two treatments. One-way ANOVA analysis was performed to compare different treatments at each time point. The analysis was performed by Tukey-Kramer HSD test pairwise comparison test for parametric values or Wilcoxon for non-parametric values. A two-way ANOVA analysis was performed to compare different treatments at different time points. The statistical analysis was conducted using JMP Pro 15 software (SAS Institute, Cary, North Carolina, USA). Different letters or asterisks indicate significant differences at P≤0.05.

### Example 1

### dsRNA Penetrates the Emergence Zone of the Hyphae and Inhibit B. cinerea Germination and Growth

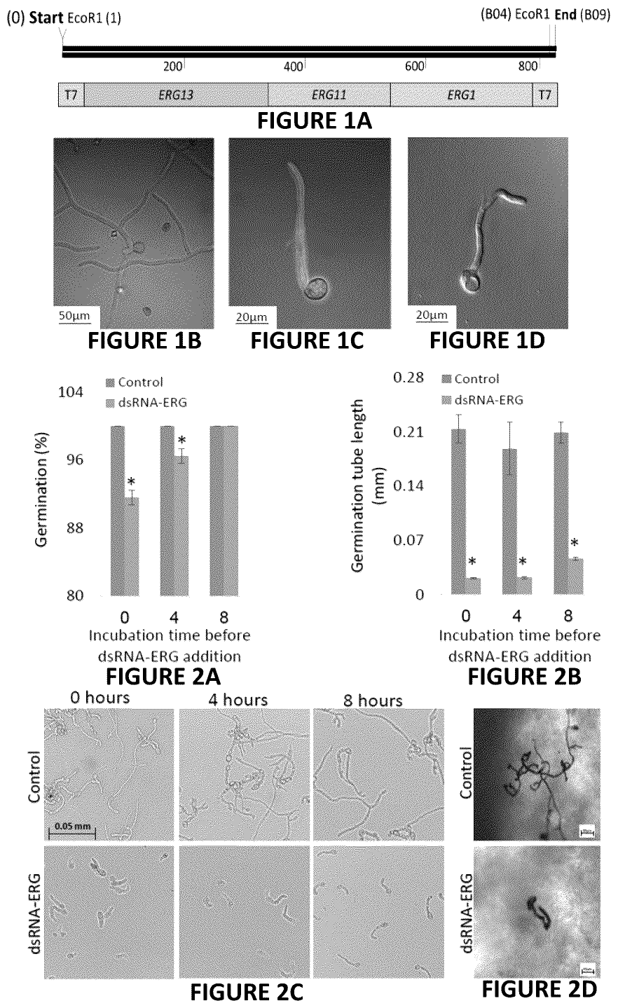

Three different genes in the ergosterol biosynthesis pathway of B. cinerea were chosen as targets. Sequences from erg13, erg11, and erg1 were joined to yield a construct in a total length of 751 bp (dsRNA-ERG; FIG. 1, see Materials and Methods). For positive control, another construct targeting B. cinerea DCL1/DCL2 dicer (dsRNA-Dicer) was cloned in a similar manner. To verify that B. cinerea is capable of taking up external dsRNA from the environment, a fluorescent dsRNA construct was prepared by incorporation of Cy5 labeled nucleotides into the sequence of dsRNA-ERG or dsRNA-Dicer. The results showed that the dsRNA was taken up and internalized near the emergence zone of the hyphae from the conidia in a punctate manner (FIG. 1).

B. cinerea growth from conidia was monitored over 50 h in the presence of different amounts of dsRNA-ERG and showed a gradual decrease in fungal growth in a dose-dependent manner in the concentration ranges of 200-800 ng (1-4 ng/μl) of dsRNA-ERG. In vitro germination assay showed a significant reduction in germination rate and germination tube length compared to control when dsRNA-ERG was added to the growth media at the beginning of the incubation (FIGS. 2A-2C). The addition of dsRNA-ERG had a slight effect on the percent of germination when the dsRNA was applied after 8 hours of conidia incubation (FIG. 2A). However, the germination tube length remained significantly lower (FIGS. 2B-2C). To evaluate the effect on germination in vivo, B. cinerea was inoculated on grapes treated with water (control) or dsRNA-ERG and then stained with lactophenol blue. B. cinerea treated with dsRNA-ERG on grapes exhibited a shorter germination tube (FIG. 2D) compared to B. cinerea which grew on water treated grapes. These results suggest that dsRNA-ERG is more effective in inhibiting fungal germination tube elongation than the percent of germination.

### Example 2

### dsRNA Targeting Ergosterol Biosynthesis Inhibits Gray Mold Development on Fruits

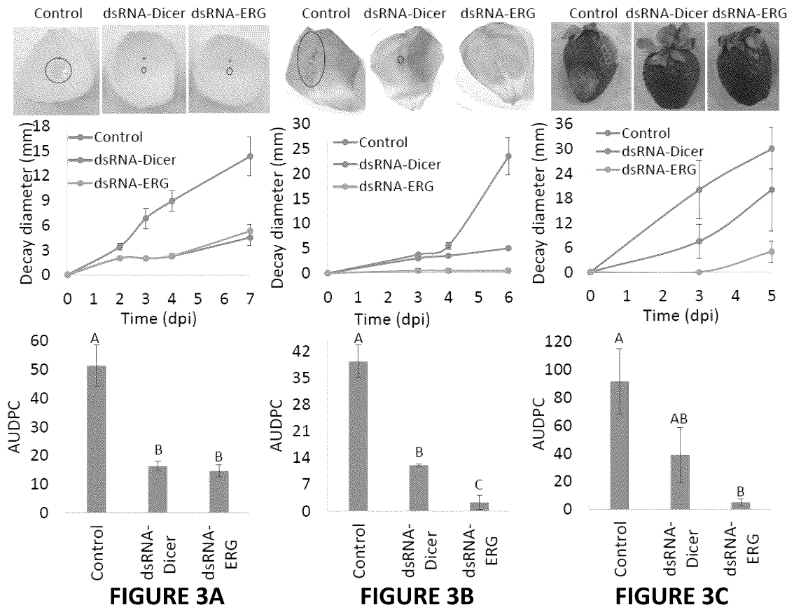

dsRNA-ERG was applied externally to various crops following inoculation with B. cinerea conidia and monitored for decay development. Treated tissue exhibited a slower decay development rate compared to the control (water treated) as well as a smaller decay diameter around the inoculation site (FIG. 3). Calculation of the area under the disease progress curve (AUDPC) showed a significant reduction in decay development of approximately 5-fold in onion scale, 8-fold in rose petals, and 9-fold in strawberries, compared to control (FIG. 3). Moreover, dsRNA-ERG displayed a similar reduction or better efficacy in the reduction of rot development as dsRNA targeting Dicer encoding genes (dcl1 and dcl22; dsRNA-Dicer) (FIG. 3), which was shown previously to reduce B. cinerea decay development (Wang et al., 2016).

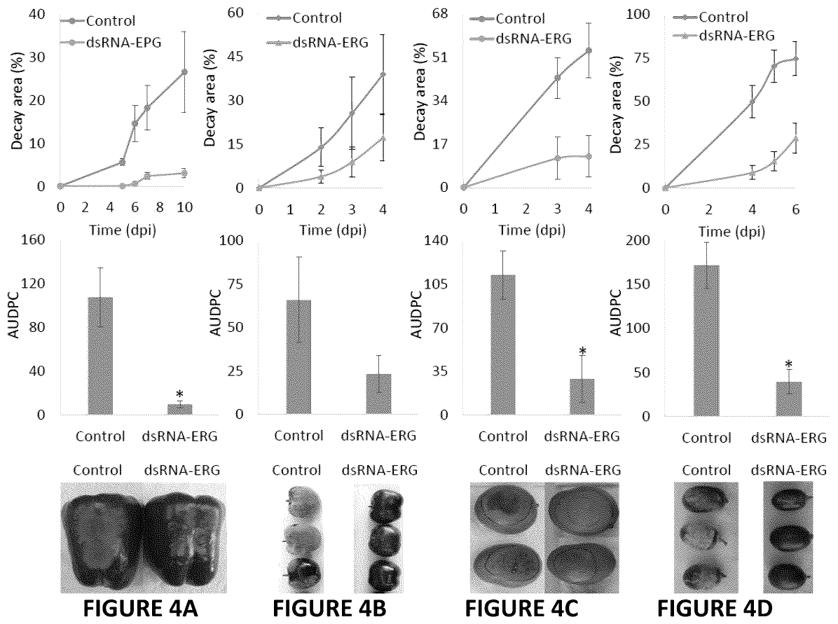

The effect of dsRNA-ERG on decay development was tested on various fruits as well. Inoculation of various fruits including tomato by B. cinerea without prior wounding led to very minor decay development in the control. This was probably due to poor penetration of B. cinerea through the waxy epidermal layer. To achieve consistent wounding, the fruit inoculation area was pre-treated by rubbing with hydrocarborundum powder to establish micro-injuries. This facilitated conidia inoculation and promoted uniform mold development on the fruit. The fruit was then sprayed by dsRNA-ERG or water (control), followed by spraying of B. cinerea conidia. In all tested fruits (bell-pepper, cherry, mango, and grape) there was a decrease in decay development rate and decay area (FIG. 4). AUDPC analysis showed a significant reduction in mold development of approximately 5-fold in bell-pepper, mango, and grapes, while in cherry fruits the decrease in decay development was not statistically significant (FIG. 4B).

### Example 3

### Systemic Fruit Protection by Application of dsRNA-ERG

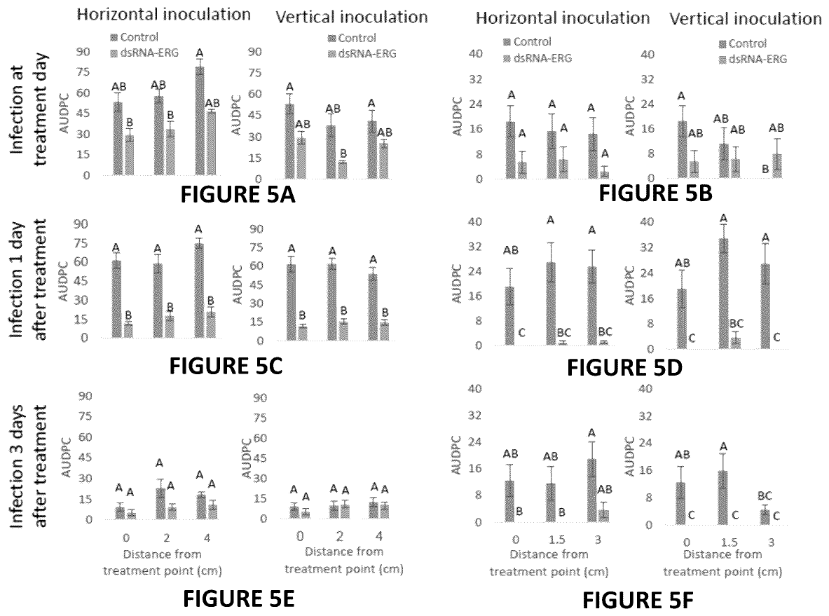

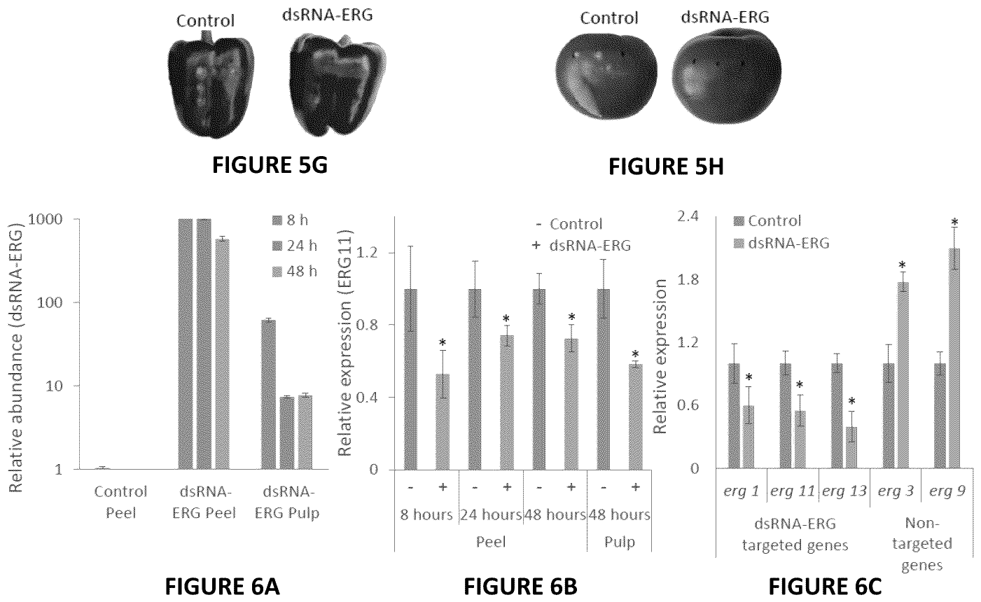

Next, the inventors aimed to evaluate the capability of dsRNA-ERG to disperse to other fruit parts and provide protection. Bell-peppers and tomatoes were used to evaluate the systemic protection of dsRNA-ERG by applying dsRNA-ERG at one point on the fruit and inoculate along the horizontal and vertical axes. The decayed area was measured every day and the AUDPC of the disease curve was calculated. The AUDPC in dsRNA-ERG treated bell-peppers and tomatoes were surprisingly lower, albeit not significantly, at all the inoculation points when inoculation was conducted on the same day of dsRNA-ERG application (FIGS. 5A-5B). However, inoculation with B. cinerea one day post-treatment resulted in a significant 4-fold reduction in decay development in both bell peppers and tomatoes compared to control fruits (FIGS. 5C-5D). It is worth mentioning that the decrease in decay development was similar at all inoculation points, close and far from the dsRNA-ERG treatment point (FIGS. 5C-5D).

The ability of dsRNA-ERG treatment to provide lasting systemic protection was evaluated by inoculation of B. cinerea three days after treatment. Bell-peppers that were infected three days after treatment did not exhibit any differences between the dsRNA-ERG treated fruits and the control group (FIG. 5E). Nonetheless, the decayed area in both groups was markedly lower compared to bell peppers that were inoculated at treatment day or one day after treatment (FIGS. 5A, 5C, and 5E). This might be due to the healing of the micro-injuries on the bell pepper's cuticle. In tomatoes that were inoculated three days after dsRNA-ERG treatment, dsRNA-ERG treated fruits showed notably lower decay development at all the inoculation points compared to control (FIG. 5F). Furthermore, a significant reduction in decay development was observed in the vicinity of the treatment point. These results suggest that dsRNA-ERG can be systemically transferred in the fruit and reduce decay development.

To evaluate penetration and action of the dsRNA-ERG, micro-injuries were generated on the grape peel using hydrocarborundum powder, then the grapes were sprayed with water (control) or with dsRNA-ERG. Next, the fruits were spray-inoculated with B. cinerea conidia, and peel (exocarp) or pulp (mesocarp) samples were collected after 8-24- and 48 hours for RNA analysis (FIG. 6). The late-time point was included as initial symptoms of decay appear 48 h post-inoculation. Eight hours post-treatment of dsRNA-ERG on the fruit peel, the dsRNA-ERG moved to the pulp and was found in the grape pulp in lesser quantities (FIG. 6A). While the relative abundance of dsRNA-ERG on the peel remained high for 48 hours post-treatment, the relative quantity in the pulp was reduced by 10-fold after 24 hours and remained almost unchanged after 48 hours (FIG. 6A). The effectiveness to down-regulates erg11 transcript over time was tested both in peel and pulp, using primers from the transcript sequence region that was not included in the dsRNA construct. In the grape peel, the down-regulation of erg11 transcript has been observed at all tested time points (FIG. 6B). In the grape pulp, at 8- and 24-hours post-infection, B. cinerea actin and erg11 were not detected in dsRNA-ERG treated grapes, while it was detected in the inoculated control, probably due to fungal inhibition. These results show that the chosen erg11 primers are specific to the transcript and cannot detect the dsRNA-ERG construct. At 48 hours, the expression of erg11 transcript levels was significantly reduced in the pulp of dsRNA-ERG treated grape compared to the control (FIG. 6B).

The dsRNA-ERG construct was designed to impact the post-transcriptional expression of three transcripts in the ergosterol biosynthesis pathway. Therefore, the expression of the three targeted transcripts; erg13, erg11, and erg1 (FIG. 6C) were quantified by qPCR as well as two non-targeted transcripts erg3 and erg9. The relative expression of the mRNA transcripts was measured by qPCR and normalized to the expression of the fungal actin. The relative expression of the three targeted transcripts was reduced on average by more than 50% in the dsRNA-ERG treated fruit, 48 hours post-inoculation, compared to control (FIG. 6C). However, the two non-targeted transcripts were significantly up-regulated, 48 hours post-inoculation, at the treated grapes compared to control indicating an attempt of compensation (FIG. 6C).

### Example 4

### dsRNA-ERG Synergism with Ergosterol-Inhibitors and Complementation by Ergosterol

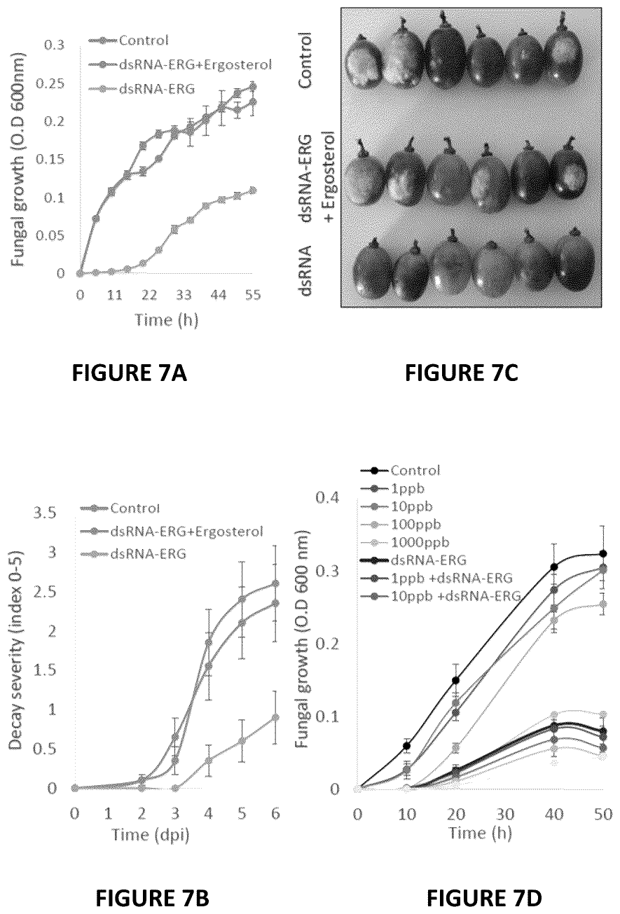

In an attempt to complement the effect of dsRNA-ERG on the growth of B. cinerea, external ergosterol was added to the dsRNA-ERG treatments. Fungal growth kinetics in vitro was determined using optical density (O.D) measurements correlating to fungal biomass. The fungal growth curves showed a major reduction when dsRNA-ERG was added to the media, compared to control (FIG. 7A). However, when B. cinerea conidia were grown in media containing external ergosterol in addition to the dsRNA-ERG, the fungal growth curve displayed a similar growth pattern as the untreated B. cinerea conidia, reaching the same final O.D levels (FIG. 7A). Importantly, the addition of ergosterol to control did not alter fungal growth. The effect of the addition of external ergosterol on fruit decay development in vivo was evaluated on infected grapes (FIGS. 7B-7C). Micro-injuries were generated on the grape peel using hydrocarborundum powder, then the grapes were spray treated with water (control), dsRNA-ERG, or dsRNA-ERG combined with external ergosterol. The fruits were inoculated by spraying with B. cinerea conidia and assessed daily for decay severity. dsRNA-ERG treatment reduced B. cinerea mold development rate and decay severity by more than 50% for 6 days post-inoculation (dpi), compared to control (FIGS. 7B-7C). Conversely, the addition of external ergosterol complemented the decay development and restored decay progression to a similar level to control (FIGS. 7B-7C). The results of reduced mRNA accumulation and complementation by exogenous ergosterol suggest that the inhibition in rot development is a result of the lack of ergosterol synthesis.

It was of interest to explore the use of spray-induced gene silencing (SIGS) in combination with a commercially used fungicide. The fungicide prochloraz is an ergosterol-inhibitor of the enzyme lanosterol 14α-demethylase (CYP51A1; encoded by erg11), which is necessary for the production of ergosterol. However, the fungicide also has multiple targets in animal systems that indicate a need for restricting its use (Vinggaard et al., 2006). Increasing concentrations of ‘Prochloraz’ in the growth media (1-1,000 ppb) resulted in a dose-dependent reduction of fungal growth as measured by O.D (FIG. 7D). When 4 ng/μl dsRNA-ERG were added, the inhibition of fungal growth was augmented (FIG. 7D). The combination of dsRNA-ERG with multiple concentrations of ‘Prochloraz’ showed a synergistic decline in fungal growth compared to each fungicide treatment or dsRNA-ERG treatment alone (FIG. 7D). Another fungicide, Fludioxonil has recently been shown to act on triosephosphate isomerase activity to induce methylglyoxal stress that alters sensing in a histidine kinase inducing fungal death (Brandhorst and Klein, 2019). ‘Fludioxonil’ reduced B. cinerea growth in a non-linear manner, a greater and non-synergistic reduction in fungal growth was achieved by the addition of 4 ng/μl dsRNA-ERG (data not shown). These results indicate that the application of dsRNA-ERG could significantly reduce the amount of fungicide needed to inhibit fungal growth.

### Example 5

### Synthesis and Characterization of LDH

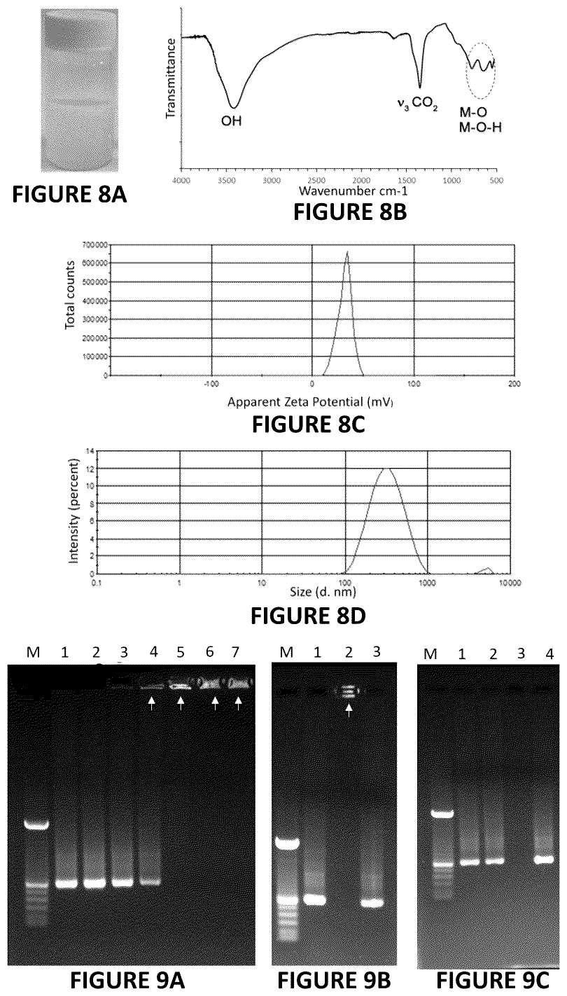

MgAl-layered double hydroxide clays with an Mg/Al ratio of 3 (LDH) were prepared using a modified co-precipitation method (Duan and Evans, 2006; Xu et al., 2006). The synthesis produced translucent dispersions. Upon irradiation with a laser beam, LDH solutions displayed a Tyndall effect of light scatter (FIG. 8A), confirming the colloidal nature of the dispersions. The LDH exhibited an FT-IR spectrum typical for hydrotalcite-like compounds (FIG. 8B). The spectrum displays intense broadband at 3,400 cm⁻¹, corresponding to the H-bonding stretching vibrations of OH groups in the brucite-like layer and water molecules. The band at 1,350 cm⁻¹ is identified as the antisymmetric stretching mode v3 of NO₃ (Goebbert et al., 2009), and the bands at 770, 637, and 545 cm⁻¹ can be attributed to M-O and M-O—H stretching vibrations (Xu et al., 2008). Doppler velocimetry measurements showed narrow Z-potential distribution (FIG. 8C) with an average value of +35 mV due to the net positive charge of LDH layers. The dynamic light scattering (DLS) shows that the particles have a monomodal size distribution (FIG. 8D) with an average particle size of 266 nm and a modest polydispersity index (0.275).

### Example 6

### LDH-dsRNA Complex and RNase Protection

The capacity of the LDH to bind and release dsRNA was evaluated by gel retardation assay. This assay is based on the inability of dsDNA complexed with LDH to penetrate and migrate through the pores of the agarose gel (Ladewig et al., 2010; Li et al., 2014). No detectable binding was observed in the absence of LDH or when the dsRNA to LDH mass ratios was low (i.e., 1:1 and 1:5). In this case, the free dsRNA-Dicer (490 bp) migrated towards the anode as a band stained with ethidium bromide. However, at a mass rate of 1:10, a significantly lower intensity band could be observed, and at the ratios 1:20, 1:40, and 1:80, no detectable free RNA was visualized. Reciprocally, the dsRNA was detectable within the loading well at the ratios of 1:20, 1:40, and 1:80 (FIG. 9A, Line 5-7). This result indicates that dsRNA is fully bound to the LDH particles at a mass ratio of 1:20. As expected, treatment at acidic conditions (release buffer, pH=3) triggered the discharge of dsRNA from the LDH particles (FIG. 9B, line 3). Henceforth, the quantity of the dsRNA used for all experiments described in this work was 15 ng/μl, which approximates a ratio of 1:60.

The capability of LDH to protect dsRNA molecules from degradation was studied by RNase-protection assay. When treated with the promiscuous endonuclease benzonase, the naked dsRNA underwent total degradation while the dsRNA complexed to LDH remained intact (FIG. 9C, compare lanes 3 and 4).

### Example 7

### LDH-dsRNA Complex Reduces B. cinerea Growth

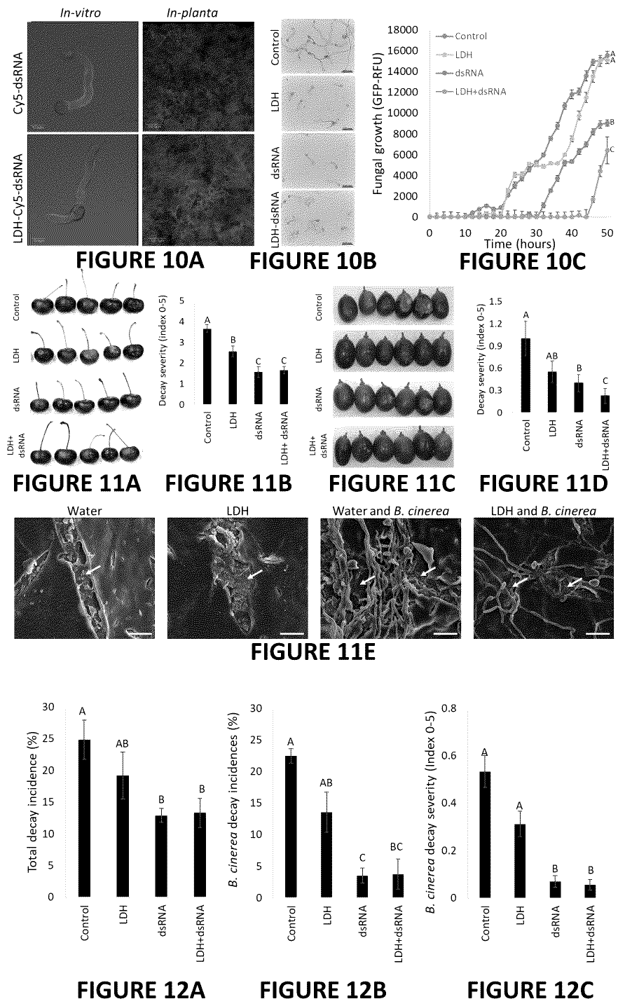

To compare the uptake of the naked dsRNA alone and LDH-dsRNA complex, the dsRNA was labeled with cy5 fluorescent dye. In both cases, after 24 hours of incubation, the fluorescent dsRNA penetrated the B. cinerea cell both in vitro and in vivo on grapes (FIG. 10A). Next, fungal growth was recorded to evaluate the effect of dsRNA quantitatively on fungal germination and growth when applied alone or in the LDH-dsRNA complex (FIGS. 10B-10C). In germination assays, both dsRNA and LDH-dsRNA complex significantly delayed B. cinerea germination in vitro (FIGS. 10B and 16). To follow fungal growth, B. cinerea expressing the fluorescent protein GFP was used, and fungal growth kinetics in vitro was determined using fluorescent intensity measurements that correlate to fungal biomass. Thus, significant growth began after 20 h in the controls but only after 30 and 45 h with dsRNA or LDH-dsRNA treatments, respectively (FIG. 10C). After adding dsRNA to the growth media, the fungal growth was reduced by 40%, and the LDH-dsRNA complex reduced fungal growth by 50% (FIG. 10C). Direct observation of germination after 20 h showed that dsRNA decreased germination by 25%, while the LDH-dsRNA complex reduced the germination rate by 70% (FIG. 16).

Interestingly, dilution of the LDH, dsRNA or the LDH-dsRNA complex from 15 ng/μl showed that lower concentrations were less effective in inhibiting germination. However, they both showed effective inhibition of germination tube length down to 3.75 ng/μl (FIG. 16C). These results indicate that B. cinerea can uptake dsRNA when applied alone or in the LDH-dsRNA complex, leading to inhibition of fungal germination and growth in vitro. It also appears that hyphal growth is more sensitive to the presence of dsRNA than the initial germination.

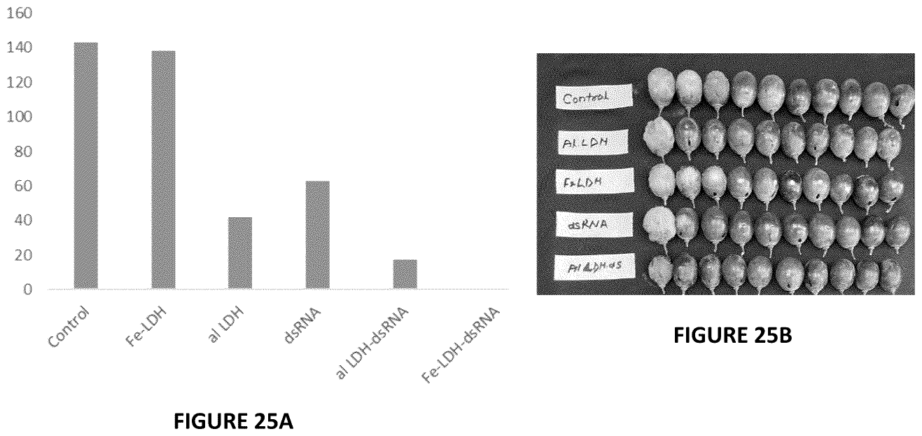

Further to the above, the inventors showed that Mg-LDH-dsRNA particles inhibit fungal germination in grapes. Specifically, the inventors showed that Mg-LDH-dsRNA provides a substantially improved germination compared to naked dsRNA, which is reflected by the reduction in lesion area (FIGS. 25A-25B). This was exemplified for both Mg—Al-LDH-dsRNA, as well as for Mg—Fe-LDH-dsRNA. In that regard, the anti-fungal effect of Mg—Fe-LDH-dsRNA was even more pronounced in the current study (FIG. 25A).

### Example 8

### LDH-dsRNA Complex Reduces Gray Mold Caused by B. cinerea

The effect of dsRNA and the LDH-dsRNA complex on gray-mold development in fruit was examined. Grapes or cherries were gently rubbed with carborundum to create controlled micro-injuries that potentiate the incidence of infection. This was followed by spray treatment by water (control), LDH, dsRNA, or LDH-dsRNA complex. The treated fruit was then spray-inoculated with B. cinerea conidia, and decay incidence and severity were measured daily. In cherries, most of the fruit developed decay, and the decay incidence in the control groups (water and LDH) was high (100% and 90% respectively; FIG. 17). However, in the treatment groups (dsRNA and LDH-dsRNA), the decay incidence was significantly lower (approximately 60% and 80% less decay incidence, respectively; FIG. 17). Moreover, naked dsRNA and LDH-dsRNA complex treatments significantly reduced the decay severity by 2-fold (FIGS. 11A-11B). In grapes, the decay incidence in control was lower four days post-inoculation (dpi) compared to the cherries. Nevertheless, the decay incidence was even lower in the dsRNA and LDH-dsRNA treatments (FIG. 17) as well as the decay severity (FIGS. 11C-11D). Area under disease progress curve (AUDPC) calculation showed a 2-fold decrease in LDH and dsRNA treatments and a 3-fold decrease in LDH-dsRNA complex compared to control (FIG. 11D).

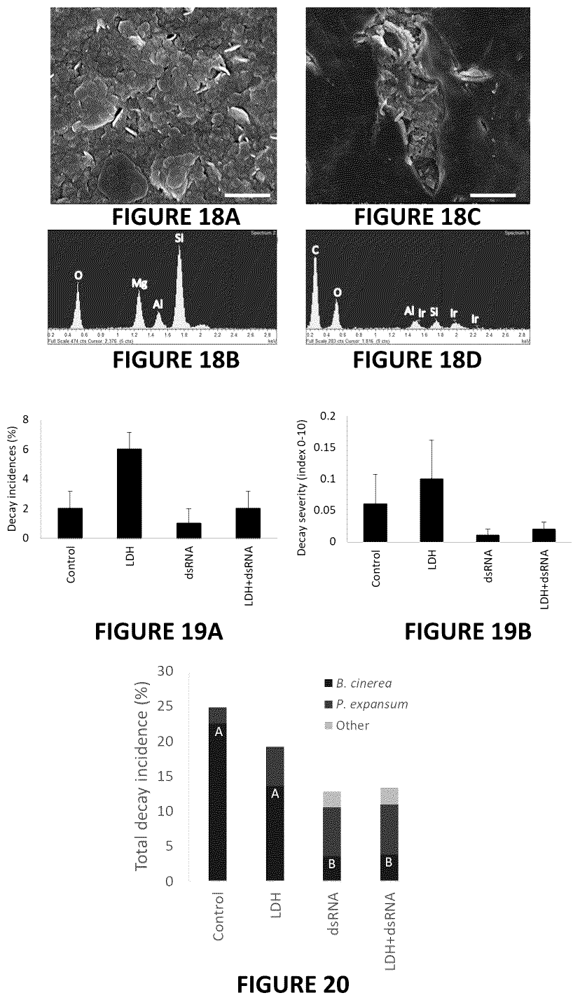

To deepen the understanding of the effect of LDH alone on decay development, water or LDH-treated grape peels with and without inoculation were visualized with HR-SEM. The images demonstrated the micro-injuries created by carborundum abrasion (FIG. 11E). The water and LDH-treated peels displayed different morphologies. The water-treated peels demonstrated scar injuries of up to 100 μm, while the injuries in the LDH-treated samples seemed to be partially physically blocked and filled by the LDH particles. Notably, direct EDS analysis of LDH samples revealed both aluminum and magnesium (FIG. 18). EDS analysis of the scar tissue showed that they contained aluminum but not magnesium, which may indicate the presence of residual clay sheets inside the micro-injuries. Interestingly, visualization of the peels 72 hours post-inoculation with B. cinerea demonstrates less development of fungal hyphae in the LDH treatment without dsRNA than in the water treatment (FIG. 11E). These results may suggest that LDH alone can serve as a partial barrier (FIGS. 16C, 11B, and 11D-11E) interfering with B. cinerea colonization.

### Example 9

### The Effect of LDH-dsRNA on Natural Infections and the Specificity of dsRNA Protection

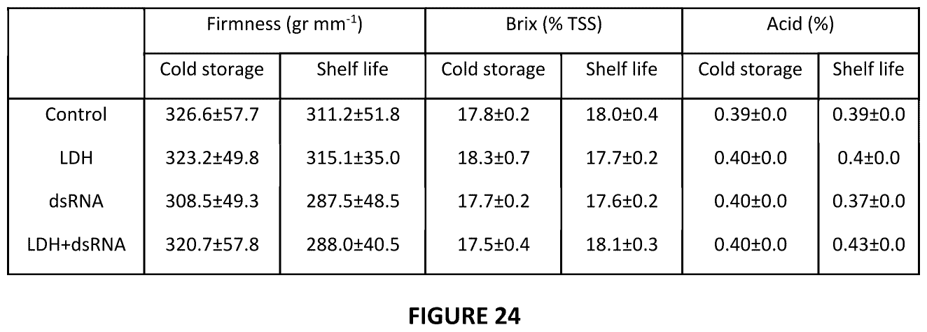

Infections of grape tables occur also in the field before harvest when the fungi remain latent. Furthermore, the majority of fruit and vegetables are stored postharvest before marketing. Taken together, it was crucial to examine the efficacy of dsRNA treatments in promoting protection during the different storage stages. To this end, the effect of LDH, dsRNA, or LDH-dsRNA was assessed on spontaneous decay development and quality parameters in table grapes during an extended period of fruit storage. In these experiments, fruit quality evaluation of treated fruit was conducted during critical time points during storage and shelf life. The quality parameters can be divided into two main categories: physiological and sensory parameters such as acidity, sugar level, firmness, and pathological parameters such as decay incidence and severity. In all the four treatments (water, LDH, dsRNA, and LDH-dsRNA), there were no significant differences among the treatments in the sensory quality evaluation (FIG. 24).

To establish the efficacy of dsRNA formulations, grapes were spray treated with water (control), LDH, dsRNA, or LDH-dsRNA complex and stored at 0° C. for three weeks (representing a period of cold storage) following one-week storage at 22° C. (representing a period of shelf life). After cold storage, the total decay incidence was relatively low, while in dsRNA treatment, the total infected fruit was even lower, although not statistically significant (FIG. 19). However, after shelf life, the occurrence of rotten fruit increased in all the treatments (FIG. 12A). In the control group, 25% of the fruit were rotten, while in LDH treatment, there was an insignificant reduction in rotting, with approximately 20% of the fruit having decay (FIG. 12A). Both dsRNA and LDH-dsRNA complex exhibit a significant decrease of 2-fold in the rotten fruit incidence compared to control (FIG. 12A).

As the inventors checked natural decay, and the fruit was not inoculated with specific fungi, it was of interest to identify the fungal pathogen that caused the decay. In this case, when only decay that was caused by B. cinerea was measured, the effect of the dsRNA and the LDH-dsRNA complex was much more significant. In control, a large percent of the fruit decay was caused by gray mold, approximately 23%-25% of the total. In grapes that were treated with dsRNA or LDH-dsRNA, the percentages of gray mold decreased to about 5% (FIGS. 12B and 20). The LDH treatment also contributed to a slight insignificant reduction in decay development caused by B. cinerea infection with around 13.5% of rotten fruit (FIG. 12B). The decay severity caused by B. cinerea showed that LDH treatment did not significantly affect the severity of the gray mold, while both dsRNA and LDH-dsRNA complex significantly reduced the gray mold incidence and severity by 5-fold compared to the control (FIGS. 12B-12C). These results emphasize the specificity of the dsRNA protection and the need to adjust the dsRNA for maximizing protection.

### Example 10

### LDH-dsRNA Complex has Prolonged Effect on Reduction of Decay Development

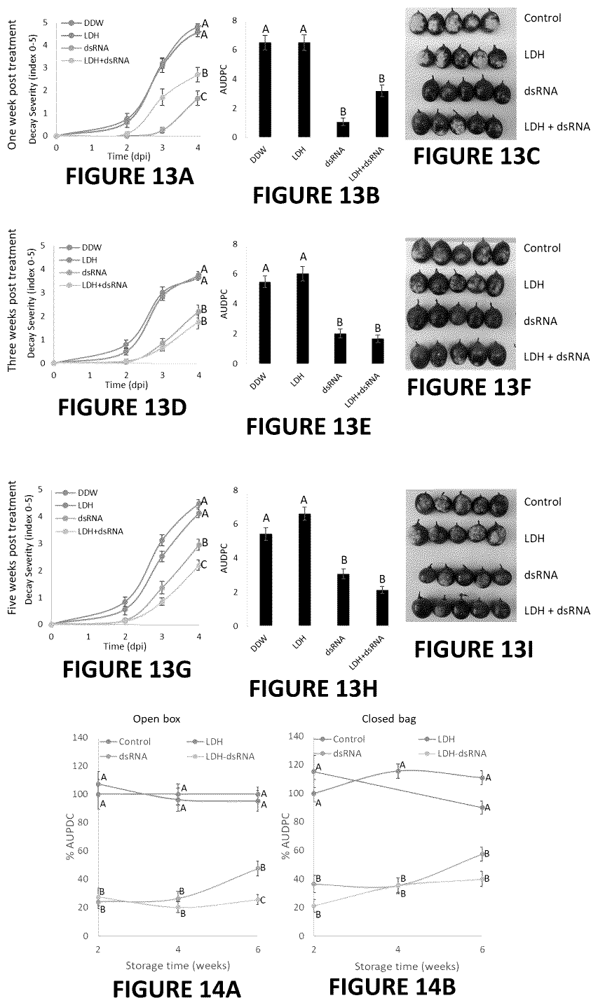

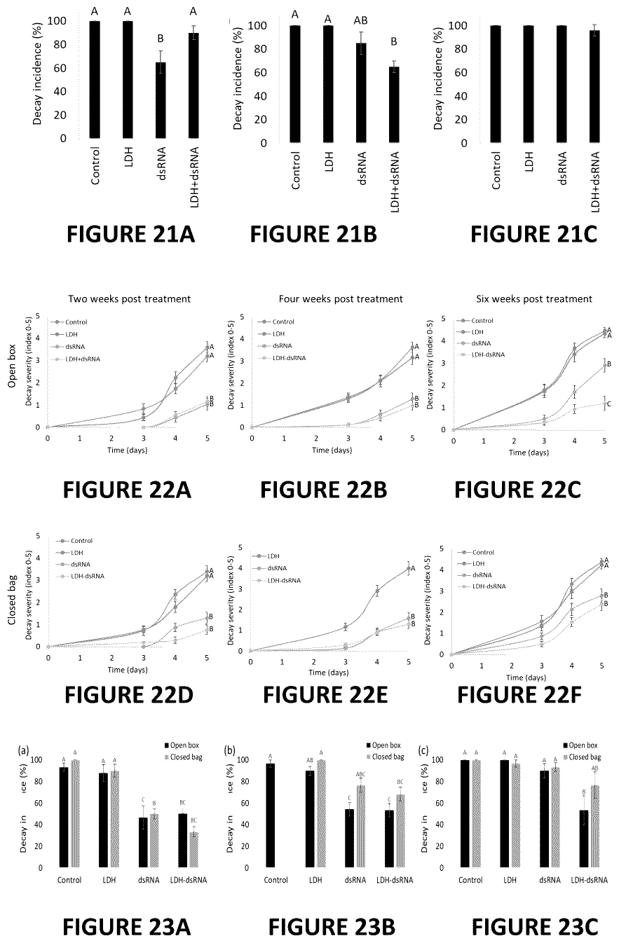

One of the challenges in food storage is maintaining long-term freshness, and it is of interest to examine if LDH contributes to dsRNA stability enabling its ‘slow release’. To this end, grapes were sprayed with water (control), LDH, dsRNA, or LDH-dsRNA and stored at 0° C. for one, three, or five weeks (cold storage). This was followed by five days of examining fruit decay development during shelf life in the following manner. At the end of each storage period, the grapes were treated with carborundum followed by spray inoculation with B. cinerea, and decay severity was recorded every day. The LDH-treated grapes did not change the decay development compared to the control at all time points. However, dsRNA and LDH-dsRNA complex treatments significantly reduced the gray-mold development at every time point (FIG. 13). According to the disease progress curve, as well as the AUDPC calculations, one week of cold storage, there was a reduction of approximately 50% in decay severity in the LDH-dsRNA complex treatment compared to control, while the treatment with dsRNA had an even better reduction of 80% in decay severity (FIGS. 13A-13C) and decay incidence (FIG. 21A). Three weeks post-treatment, both dsRNA and LDH-dsRNA complex similarly decreased the decay development by 65% (FIGS. 13D-13F) however, the LDH-dsRNA complex reduced the decay incidence by 20% compared to the other treatments (FIG. 21B). When the grapes were inoculated five weeks post-treatment, there was no significant difference in the decay incidence among the treatments (FIG. 21C), however, the decay severity trend was changed, and although both dsRNA and LDH-dsRNA complex significantly reduced the decay severity, dsRNA decreased the severity by 50%, and the LDH-dsRNA complex reduced the decay development by 65% (FIGS. 13G-13I). These results indicate prolonged and slow-release effects by the LDH-dsRNA complex (FIG. 13).

### Example 11

### Storage Conditions Affect the dsRNA Release Rate from LDH

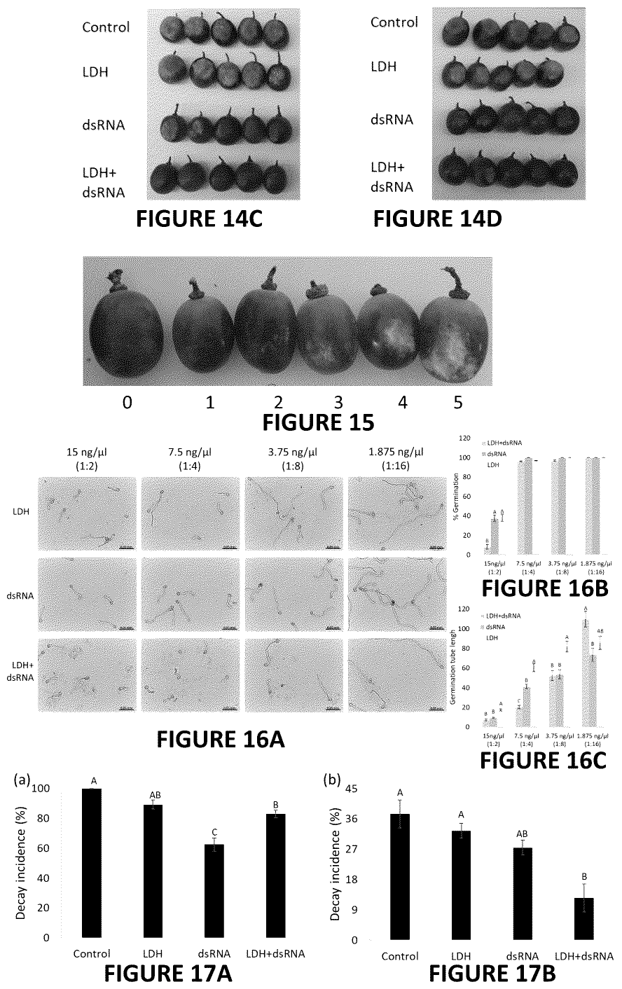

To further assess conditions that affect dsRNA stability, the inventors examined how storage in elevated levels of CO₂ and humidity would affect dsRNA release from the LDH-dsRNA complex, as these conditions are prevalent in storage protocols. Grapes were treated with water (control), LDH, dsRNA, and LDH-dsRNA and stored at 0° C. under two conditions: open box, i.e., regular atmosphere and closed bags with modified atmosphere packaging (MAP). The latter is meant to increase levels of CO₂ and humidity. The CO₂ levels in the MAP stood at approximately 0.5±0.02%, while in the regular atmosphere, it was 0.04 percent. The relative humidity in the MAP stabilized at 93-95%, while the cold room relative humidity stood at 85%. Grapes from each treatment were spray inoculated with B. cinerea every two weeks after carborundum treatment and examined 3-5 days later. In all the experimental time points and in both of the storage conditions, there was a 60-80% reduction in decay severity in both dsRNA and LDH-dsRNA treatments compared to control and LDH alone. It was evident that the effectiveness of the dsRNA alone in preventing decay development decreased with time. Remarkably, LDH-dsRNA treatment in the open box retained efficacy in reducing decay development (incidence and severity) and did not change during the six weeks of storage (FIGS. 14A, 22A-22C, and 23). However, the LDH-dsRNA treatment in the MAP (higher CO₂ and humidity) had a similar trend as the dsRNA alone, and its efficiency decreased along the storage period, which suggests a rapid release of dsRNA from the LDH (FIGS. 14B, 22D-22F, and 23). Nonetheless, after six weeks of storage, the LDH-dsRNA treatment in modified and regular atmospheres exhibits better decay control than dsRNA alone. These results indicate that storage packaging influences the dynamics of LDH-dsRNA stability.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. An anti-fungal composition comprising a plurality of particles comprising:
a. at least one dsRNA molecule comprising a nucleic acid sequence complementary to at least one transcript of at least one essential gene of said fungus; and
b. LDH.

2. The anti-fungal composition of claim 1, wherein any one of: (a) said anti-fungal composition comprises at least one feature selected from the group consisting of: (i) Magnesium to Aluminum m:m ratio of between 2 and 4; (ii) Zeta potential of between 30 mV and 50 mV; and (iii) a particle size of between 150 nm and 350 nm; (b) said anti-fungal composition being characterized by being capable of reducing or inhibiting at least one fungal activity for a period of between 1 and 6 weeks; (c) said at least one essential gene encodes for at least one protein involved in the ergosterol production pathway; (d) said at least one essential gene comprises three essential genes involved in the ergosterol production pathway, and optionally wherein said three essential genes involved in the ergosterol production pathway are erg13, CYP51, and erg1; and (e) any combination of (a) to (d).

3. The anti-fungal composition of claim 1, wherein said at least one dsRNA molecule is of a length of between 500 base pairs (bp) and 1,000 bp.

4. The anti-fungal composition of claim 3, wherein said at least one dsRNA molecule comprises a first RNA sequence derived from said erg13, followed by a second RNA sequence derived from said CYP51, followed by a third RNA sequence derived from said erg1, optionally wherein any one of said first, second, and third RNA sequences is of a length of between 20 bp and 400 bp, wherein any one of said first, second, and third RNA sequences has a complementarity level of between 70% and 100% to erg13, CYP51, and erg1, respectively, or to a transcript thereof, or both.

5. The anti-fungal composition of claim 4, wherein said at least one dsRNA molecule comprises the nucleic acid sequence set forth in any one of SEQ ID Nos: 4-7.

6. The anti-fungal composition of claim 1, formulated for at least one administration route selected from the group consisting of: spraying and dipping.

7. A method for treating or preventing a fungal infection in a plant in need thereof or a part thereof, the method comprising administering to at least a portion of said plant an effective amount of at least one double stranded RNA (dsRNA) molecule comprising a nucleic acid sequence complementary to at least two transcripts transcribed from at least two essential genes of a fungus inducing said fungal infection, thereby treating or preventing the fungal infection in the plant or a part thereof.

8. A method for treating or preventing a fungal infection in a plant in need thereof or a part thereof, the method comprising administering to at least a portion of a plant an effective amount of a particle comprising:
(i) at least one dsRNA molecule comprising a nucleic acid sequence complementary to at least two transcripts transcribed from at least two essential genes of a fungus inducing said fungal infection; and
(ii) a layered double hydroxide (LDH), thereby treating or preventing a fungal infection in the plant or a part thereof.

9. The method of claim 8, wherein said particle comprises said at least one dsRNA molecule and said LDH at a mole per mole (m:m) ratio of between 1:20 and 1:80.

10. The method of claim 7, wherein said at least two essential genes are of the same pathway, and optionally wherein said pathway is ergosterol production pathway.

11. The method of claim 7, wherein said at least two essential genes are selected from the group consisting of: 3-hydroxy-3-methylglutaryl-CoA synthase (erg13), Sterol 14-demethylase (CYP51), and Squalene monooxygenase (erg1), and optionally wherein: (i) said at least two essential genes comprises all three of egr13, CYP51, and erg1; (ii) said at least one dsRNA molecule comprises a first RNA sequence derived from said erg13, followed by a second RNA sequence derived from said CYP51, followed by a third RNA sequence derived from said erg1, and optionally wherein: (a) any one of: said first, second, and third RNA sequences is of a length of between 20 bp and 400 bp; (b) any one of said first, second, and third RNA sequences has a complementarity level of between 70% and 100% to erg13, CYP51, and erg1, respectively, or to a transcript thereof; and (c) both (a) and (b); or (iii) both (i) and (ii).

12. The method of claim 11, wherein said at least one dsRNA molecule comprises the nucleic acid sequence set forth in any one of SEQ ID Nos: 4-7.

13. The method of claim 7, wherein said fungus is selected from the division Ascomycota, and optionally wherein said fungus belongs to a genus selected from the group consisting of: Botrytis, Alternaria, Aspergillus, Blumeria, Cercospora, Colletotrichum, Geotrichum, Fusarium, Lasiodiplodia, Magnaporthe, Monilinia, Mycosphaerella, Penicillium, Phytophthora, Puccinia, Rhizophus, Rhizoctoniat, Sclerotinia, Ustilago, and any combination thereof.

14. The method of claim 7, wherein said administering is by spraying, dipping, or both.

15. The method of claim 7, wherein said administering comprises multiple administrations, and optionally wherein said multiple administrations are 1 week to 4 weeks apart.

16. The method of claim 7, further comprising co-administering to said at least a portion of a plant an amount of a fungicide being at least 10% lower than an effective amount of said fungicide when administered alone.

17. The method of claim 7, wherein said at least a portion of a plant comprises any one of: a leaf, a fruit, a flower, and any combination thereof.

18. The method of claim 7, wherein said administering comprises post-harvest administration.

19. The method of claim 7, further comprising subjecting said at least a portion of a plant to at least one abiotic condition selected from the group consisting of: (i) CO₂ level of between 0.01% to 5%; (ii) relative humidity of between 80% and 98%; and (iii) both (i) and (ii), and optionally wherein said subjecting is after said administering.


SEQUENCE LISTING (27 sequences)

SEQ ID NO: 1 - DNA, 1965 bp, Botrytis cinerea
  source 1..1965: mol_type = genomic DNA
gtgttactgttaatctcgaacaatactaatcccaatctttgtcttcagtctcgtcaattgtctcgactgtacatacaacatctcagggcttcctttctagatccccctttatcttatatcttcaaataaatctctagaagtacactctacacaacaccacaccacacacaccgcccctcgccatcatgtctgctcgtcctcaaaacatcggcatcaaggccattgaaatttacttcccaagtcagtgtgttgctcaagaagaactcgagaaattcgatggcgttagtgcgggaaaatacacaattggtcttggtcaaactaagatgagcttctgcgacgatagagaagatatttactcttttgccttgaccgttacctcgcgccttctcagcaagtacagcattgataccaaaaccattggacgtcttgaggtcggtacagagactcttctcgacaaatcgaaatccgtaaaatcagttcttatgcaattgtttggagataactcgaatattgagggaattgacactgttaatgcatgctacggtggtaccaacgccgttttcaacgctgtcaactgggtagaatcatctgcatgggatggaagagacgccattgtcgttgctggagatattgctctatatgccaagggtgctgcacgtccaactggaggtgctggagctgttgccatgttgattggaccaaatgctccagttgttgtcgagcctggtcttcgcggatcctacatgcaacatgcctacgatttctacaagccagatcttacaagtgaatacccaatcgttgacggtcacttctctttgagatgctacactgaagcggttgatgcttgctacaaggcctacaacaagagagaacaaactcttaagcctctcgccaacggacataccaatggtgccgttgccgaggaatcaacaaaaactcctcttgaccgtttcgattacatggctttccacgcccctacctgcaagctcgtttccaaatcatacgcccgtatgctctacaacgactatcttgccaacccaaccgcatcagcttttgccgatgtaccagctgagttaagggatatggattacgccaagtctttgagcgacaaggtcgtcgagaagacattcatgggattgacaaagaagcgtttcaacgagcgtgttcagcctagtatccaagtcccaacattctgtggaaacatgtacactgccagtgtttatggtggattggttggtttgttgagcaatgttgatagtgccgcccttcaaggaaagagaatcggtattttcagttatggaagtggtttggctgcaagtttgttctcattaaagatcaacggctccactgaggccatttcaaaggctttgaacttgcaagaaagactcgatgctcgcagaaccgtcgccccagaagtttacgaagagttctgcgctctccgcaaggaagcccatctccaaaagtcatacacacccaagggtagcccagataccattgtcgagggtacctactacctcaagagcgtcgacgagatgttccgcagagaatatgaaatcaaggcataaattctcaaaattaattttaatttgacagcgattctttctgcttgcgacttgcatagattaaatgggatggctactttctgccttcgaattgcatgttcacgattatcctctacagggcgctatattcgcttgcatatacttcacttctagatagaccaggagtgtggtaaatagagagtttgggagtgaaggggagggatggggatggaaatttcaatgcttgggattatttcagtgaaataggaatttttacattttgatactgatgagggaaaggtgagggagaaacagcaaaattgaagcattgtgtggatgctagttgaatcttaggtcttgacctacacatggatttagacaaacaatgatagatatgagaatgacaaatttggatcttgattca

SEQ ID NO: 2 - DNA, 2140 bp, Botrytis cinerea
  source 1..2140: mol_type = genomic DNA
tggcacgacaagtcttctcaactttctcttctctactttgtacaccaccttttcgtgtatttgtgcaccggcattatatgcgatggggattcttgaagctgtaaccgggccattggctcaggaaatttcgcagcggtcaactggcgttgttgtagctgctggcgtggcagcattcatcgttctatctgtcgttctcaatgttttgaaccaagtgttatttgcaaaccccaatgagcctcccatggtcttccactggctcccagtaattggcagcactatcacttatggtatggacccttacaaattcttcttcgattgtcgcgcaaagtatggtgacattttcacatttgtcttgcttggaaagaagaccaccgtatatctcggacgcaagggcaacgactttattctcaatggcaagctcaaggatctcaacgcggaggagatatatactgttttgacaacccccgtatttggcaaagatgtagtttacgactgcccaaatgcgaagttgatggagcaaaagaagttcatgaaaattggcttgtctacagaagctttccgatcctacgtcccaatcatacaaatggaggtggaaaactttatgaagcgttcttcggcgttcaaaggtccaaagggaactgctgacattggtcccgctatggctgaaatcaccatctacactgcttcgcacactctgcaaggaaaggaagtccgcgatcgattcgatacctcctttgcctctctctaccacgacctcgacatgggcttcagtcctatcaactttatgcttcactgggcccctctccctcacaaccgtgcccgcgatcatgcccagcgaactgtagccaaaacctatatggatatcattcaaaaccgacgtgctcaagctacggaagcagagttcaaatctgatattatgtggcagttgatgcgctcgtcttacaaggatggaactccagttccagataaggaaatcgctaacatgatgattgctcttctcatggccggacaacattcttcctcatcttctatctcgtggattatgcttcgcctcgcctcacgcccagacattatggaagaactctaccaagaacaaatccaagtcttaggtgctgatctccctgctctcaagtatgaggatttgtccaaactccctctccatcagaacgttctcaaggaaactctacgcctccacaccccaatccattctatcatgcgcaaagttaccacaccaatgccaatcagcggaaccaaatatgtcattccaacatcacatacacttatggcatctcctggttgcacaagtcgagatgacgaattcttccccgaagcacttgagtgggatcctcacagatgggatcttggttccggccgtgttgttggaaatgatcaggatgaggaattccaagattatggttacggaatgattagcaaaggcgcttccagtccttaccttccatttggtgctggcagacatagatgcattggtgaacaattcgcgactgtacagcttgtcacgatcatggcaactgtcgttagattgttcaaatttaagaacattgatggcagcaaggatgtgattggtaccgattacgcaagtttattcaccaggccattggcgccagccgttgtagcttgggagcgacgataaatgaacggatggattaatggaggataggttacaatgacgacatggcattgcgtggagtttttaatggttcgatgctcatagaaatattaataatataccctgactttttaatctttcagaggaaggggccagttttggggaagaggggggggggggcaggtagttgattgaaagatattccctgtatgttggagtcttgtcatataggtcggattgtgaattggtggattggcaccatcttaaggggatgaacaatatgattcggctgtaattacattaataaagcattgttcaatgcactcactcacttgtcattcgagggaaatatgaagggcgacggaaggaacggaacaagcccgtgattgatgcaaatgatgccaatgtgatgaagtggattctcctccggaaaacggataagtggcgggcggttgacatgcacgagggaccgtaattggattgagacccatggaatattgcgcatacatggga

SEQ ID NO: 3 - DNA, 2624 bp, Botrytis cinerea
  source 1..2624: mol_type = genomic DNA
ggggttcaacaagcgtaccaggccaggtatgattttttatctttcatatgataatgctctgctttcctaggtacggtaccgcactccctccctccacgggctagaaaagtctagaaatgagcgagcgaatagagacggccaggataggataggtggatgggcattttaatcgtaagatttcacgttggaaacataatatactcatcatcagtcagttcatgttggccagagagagcgagagagcgagagagaggaaatcagctcattctttattgttttgttgatatatacttacatacctacatacatacacacatcgcattttgatttcttaaaatccctttttttcctacacctaccgacggttcatgacgggatatgttatatgctgcttccaaacattcattcattcattgcgcattcactcatatgattcattgattgatcgatcgattgattcacactcaagagtcatatacgaataattgctgtcatacctgccttccctcttcctcttattgtcgcagatattatatctgcaaacttaccgcctacacacttccatacctatctacttgtctacaacatcctcaactctcacataccaaacccccaaatccgattccaaaatgtcaaaaccctactccatacaagccgccagtgaagaaagacgtcgcgtctaccacgaagcagatgtagtcgtggtcggcgccggtatatttggttgcgcaatagcttatgcacttgcccaacaaggtcgcagtgtcattcttctcgaacgttggcttaaagaacccgatcgtatagtcggcgaactgctccagccaggtggtgtttccgcactcgagaaacttggtctcgcacattgtttagaagggatcgattcgataagggtgaaaggatatgaagttatataccatggaacacccgtcaccataccttatccaccaaatgctggcgcagcacaagaaggaggattcaaagcatcggagaatgaaaaaagtgccagaccagagggaagaagttttcatcatggaagatttatttcgcaattgaggaaagcgtgtgcaagtcagcccaatattacaattgtcgaaacagaagtcacagaaaccataactggtgggcacaactcaactcaagttctcggagtccacacacgaactaccaatccatctacgggcgaaaaagaagcagattgttattttggccatctcaccatcatcgcagatggatatgcctccaaattccgcaagcaatacatcaacaaaactcccattgtcaaaagtaaattctacgctctagaattaatagattgtcccatgccagctcccaatcatggaatcgtagtcctctcggacgtctccccagttctcctctatcaaatcggtacccacgaaactcgcgctctaatagatattcccgacaatactcctgctgcatctgccgctgcaggtggcgtacgaaattatattcataccgtcgtcctcccaatcttaccgccacaagttcgaccctgtttcctcaaagcccttgaagatggcaaaattccccgcagcatgccaaacagttttctccctccatccacgcaaacccaaaaaggagttcttctccttggggatgcaatgaatatgcgtcatcctttaactggcggtggcatgactgtagccttcaatgatgttgttctcctatcctctttactttctccatccaacatcccaaatttaaacgacacggtcgctataagtaaagctatgaaagaattccattggcgtcgcaaatctctttcttctatcatcaatatcctcgcccaagctctctatgcactttttgcagctaatgatccacaacttaagacattacaaaaaggatgcttttattatttcaaaagaggagggaattgtattgaaggtcctgcaggattattggcgggaattattagacaaccgttagtattgatttatcactttttttcagtggcagtattagcgatttggatcttgatgggagatattatgggaggaataaaaggattttggaaggctccttgggcaatagaacagagtatggaggttttttggaaggcgtgtgtggttatcgttccatttatgtggagcgagttgagaagttaaggggtgcatgttttgaagtggtgtgggaaagagaagagaaaggaagaaagctgtaatgtttgatgaagagatgatgaggttatttgatgtggttgacgattagaggaagatgcacatgatatactcaagatgatgaaagttcttcatggcttgacattcattatgatgtattgtgtttctgatagcgagcgaagctttatgtgtttatggcatgttaatgagcgtttaatggattgaagtggaagaggtgaaaagaagaagaggaagaggatagaacaaaagctgtattgaaattcttgagattcttcctggaattcatagaatacatctgtatgcatgcacggagtactaaatagagagagagagagacagaaagattctacataacttataattaatcaacaaatataataatactaagtctggtttttaacattattcttatgattcgagtttttgtattatataatatcatggatataatattatcta

SEQ ID NO: 4 - RNA, 234 nt, Synthetic construct
  source 1..234: mol_type = other RNA
atgctacggtggtaccaacgccgttttcaacgctgtcaactgggtagaatcatctgcatgggatggaagagacgccattgtcgttgctggagatattgctctatatgccaagggtgctgcacgtccaactggaggtgctggagctgttgccatgttgattggaccaaatgctccagttgttgtcgagcctggtcttcgcggatcctacatgcaacatgcctacgatttctacaa

SEQ ID NO: 5 - RNA, 307 nt, Synthetic construct
  source 1..307: mol_type = other RNA
ctgttttgacaacccccgtatttggcaaagatgtagtttacgactgcccaaatgcgaagttgatggagcaaaagaagttcatgaaaattggcttgtctacagaagctttccgatcctacgtcccaatcatacaaatggaggtggaaaactttatgaagcgttcttcggcgttcaaaggtccaaagggaactgctgacattggtcccgctatggctgaaatcaccatctacactgcttcgcacactctgcaaggaaaggaagtccgcgatcgattcgatacctcctttgcctctctctaccacgacct

SEQ ID NO: 6 - RNA, 210 nt, Synthetic construct
  source 1..210: mol_type = other RNA
agaagcagattgttattttggccatctcaccatcatcgcagatggatatgcctccaaattccgcaagcaatacatcaacaaaactcccattgtcaaaagtaaattctacgctctagaattaatagattgtcccatgccagctcccaatcatggaatcgtagtcctctcggacgtctccccagttctcctctatcaaatcggtacccacga

SEQ ID NO: 7 - RNA, 751 nt, Synthetic construct
  source 1..751: mol_type = other RNA
atgctacggtggtaccaacgccgttttcaacgctgtcaactgggtagaatcatctgcatgggatggaagagacgccattgtcgttgctggagatattgctctatatgccaagggtgctgcacgtccaactggaggtgctggagctgttgccatgttgattggaccaaatgctccagttgttgtcgagcctggtcttcgcggatcctacatgcaacatgcctacgatttctacaactgttttgacaacccccgtatttggcaaagatgtagtttacgactgcccaaatgcgaagttgatggagcaaaagaagttcatgaaaattggcttgtctacagaagctttccgatcctacgtcccaatcatacaaatggaggtggaaaactttatgaagcgttcttcggcgttcaaaggtccaaagggaactgctgacattggtcccgctatggctgaaatcaccatctacactgcttcgcacactctgcaaggaaaggaagtccgcgatcgattcgatacctcctttgcctctctctaccacgacctagaagcagattgttattttggccatctcaccatcatcgcagatggatatgcctccaaattccgcaagcaatacatcaacaaaactcccattgtcaaaagtaaattctacgctctagaattaatagattgtcccatgccagctcccaatcatggaatcgtagtcctctcggacgtctccccagttctcctctatcaaatcggtacccacga

SEQ ID NO: 8 - skipped

SEQ ID NO: 9 - DNA, 23 bp, Synthetic construct
  source 1..23: mol_type = other DNA
taatacgactcactatagggaga

SEQ ID NO: 10 - RNA, 252 nt, Synthetic construct
  source 1..252: mol_type = other RNA
tgcggaagaacttgaaggtttgctacacagtcaaatatgtactgcagaagatcccagcttgctgcagtactcaatcaaaggtaaacctgagactcttgcctactatgatcccttgggcccgaaattcaatactcctctttatcttcaaatgctcccgcttctaaaagacaatcctatctttcggaagccatttgtatttgggacagaagccagtagaactctaggatcttggtgtgttgaccagatctggac

SEQ ID NO: 11 - RNA, 238 nt, Synthetic construct
  source 1..238: mol_type = other RNA
ggatgccatttgctgcacgccaaaaatacatcgagcagatcttcgccttcgagtaaagctaccacttctatctattatctactataccccagagtcaaatatcatcgtgacgaaaactgtggcgagcctgagaaagattgtgcaaagtctcaacattttcgaagacccctacgttttgacactaaaaaggagtgatagcgaaaaaagtcaacgtgagctggcgaaagtactcaagagt

SEQ ID NO: 12 - DNA, 23 bp, Synthetic construct
  source 1..23: mol_type = other DNA
gctgatctccctgctctcaagta

SEQ ID NO: 13 - DNA, 22 bp, Synthetic construct
  source 1..22: mol_type = other DNA
tgtggaggcgtagagtttcctt

SEQ ID NO: 14 - DNA, 20 bp, Synthetic construct
  source 1..20: mol_type = other DNA
gaggaaagcgtgtgcaagct

SEQ ID NO: 15 - DNA, 20 bp, Synthetic construct
  source 1..20: mol_type = other DNA
ttcgcccgtagatggattgg

SEQ ID NO: 16 - DNA, 20 bp, Synthetic construct
  source 1..20: mol_type = other DNA
aagaagcgtttcaacgagcg

SEQ ID NO: 17 - DNA, 20 bp, Synthetic construct
  source 1..20: mol_type = other DNA
agggcggcactatcaacatt

SEQ ID NO: 18 - DNA, 20 bp, Synthetic construct
  source 1..20: mol_type = other DNA
tggaagtgaccgacaaatac

SEQ ID NO: 19 - DNA, 18 bp, Synthetic construct
  source 1..18: mol_type = other DNA
gagggttgtgccattgat

SEQ ID NO: 20 - DNA, 20 bp, Synthetic construct
  source 1..20: mol_type = other DNA
tcacccatttcacccagttt

SEQ ID NO: 21 - DNA, 22 bp, Synthetic construct
  source 1..22: mol_type = other DNA
gttgatccgagtccgtctattg

SEQ ID NO: 22 - DNA, 21 bp, Synthetic construct
  source 1..21: mol_type = other DNA
tacctcctttgcctctctacc

SEQ ID NO: 23 - DNA, 22 bp, Synthetic construct
  source 1..22: mol_type = other DNA
gtattgcttgcggaatttggag

SEQ ID NO: 24 - DNA, 22 bp, Synthetic construct
  source 1..22: mol_type = other DNA
tgctccagaagctttgttccaa

SEQ ID NO: 25 - DNA, 22 bp, Synthetic construct
  source 1..22: mol_type = other DNA
tcggagatacctgggtacatag

SEQ ID NO: 26 - DNA, 20 bp, Synthetic construct
  source 1..20: mol_type = other DNA
cttgcatccctcagcacctt

SEQ ID NO: 27 - DNA, 20 bp, Synthetic construct
  source 1..20: mol_type = other DNA
tcctgtggacaatggatgga